(19) United States
(12) Patent Application Publication
(10) Pub. No.: US 2026/0079433 A1
(43) Pub. Date: Mar. 19, 2026

(54) PRINTING APPARATUS, CONTROL METHOD FOR PRINTING APPARATUS, AND STORAGE MEDIUM

(71) Applicant: CANON KABUSHIKI KAISHA, Tokyo (JP)

(72) Inventor: JUN MIYAJIMA, Ibaraki (JP)

(21) Appl. No.: 19/326,490

(22) Filed: Sep. 11, 2025

(30) Foreign Application Priority Data
Sep. 18, 2024 (JP) 2024-160838

(51) Int. Cl. G03G 15/23; G03G 15/00; G06F 3/12

(52) U.S. Cl. CPC G03G 15/234; G03G 15/50; G06F 3/1205; G06F 3/1239; G06F 3/1252

(57) ABSTRACT

A control method for a printing apparatus capable of executing a print job including a mixture of simplex printing and duplex printing performs, while selectively switching based on predetermined conditions, a plurality of print control operations including at least a first print control operation which performs simplex printing and duplex printing and a second print control operation which applies, to a sheet for simplex printing present between a plurality of sheets for duplex printing, conveyance control equivalent to that for a sheet for duplex printing in such a way as to cause the sheet for simplex printing to be conveyed through a conveyance path for duplex printing after simplex printing, and, in a case where, in sheets for feeding, a predetermined sheet designated in such a manner that, when being discharged, a predetermined surface thereof faces in a predetermined direction is included, restricts application of the second print control operation.

### BACKGROUND

### Field of the Technology

The present disclosure relates to a printing apparatus, a control method for a printing apparatus, and a storage medium.

### Description of the Related Art

Conventional methods for forming images on both obverse and reverse sides of each of a number of recording sheets of paper include a method using a circulating-type sheet conveyance method. The circulating-type sheet conveyance method is a method in which, after a recording sheet of paper is conveyed to a transfer portion for image transfer, the recording sheet of paper with an image transferred to one side thereof is conveyed to a reversal portion, the recording sheet of paper reversed by the reversal portion is conveyed to the transfer portion again without being stacked in a duplex dedicated holding tray, and an image is then transferred to the reverse side of the recording sheet of paper.

Each of Japanese U.S. Pat. No. 3,880,281 and Japanese Patent Laid-Open No. 2012-3252 describes a conveyance control method for outputting, at high speed, a job which includes a mixture of simplex printing and duplex printing (hereinafter, also referred to as “simplex-duplex mixture duplex printing control”). Specifically, Japanese U.S. Pat. No. 3,880,281 describes a conveyance control method which, in a case where sheets of paper for duplex printing and sheets of paper for simplex printing are mixed, performs duplex printing while making the reverse side of each sheet of printing for simplex printing blank and thus does not interrupt duplex circulation printing (hereinafter, also referred to as “forcible duplex control”). Moreover, Japanese Patent Laid-Open No. 2012-3252 describes a further conveyance control method capable of outputting, at high speed, a job which includes a mixture of simplex printing and duplex printing (hereinafter, also referred to as “overtaking duplex control”). In the overtaking duplex control, printing on obverse sides of sheets of paper for duplex printing present posterior to a group of pages for simplex printing is performed in advance of printing for the simplex printing page group, the duplex printing sheets of paper are retracted into a duplex conveyance path, printing and discharging for the simplex printing page group are performed, and, then, printing and discharging for the remaining reverse sides of sheets of paper for duplex printing are performed. With such control operations applied, it becomes possible to output, at high speed, a job including a mixture of simplex printing and duplex printing.

With the above-mentioned control operations applied, an amount of time for which a sheet of paper with the obverse side thereof subjected to image formation for duplex printing is being conveyed through a duplex conveyance path is effectively used and simplex printing is performed in parallel with such conveyance, so that it becomes possible to considerably make a total amount of time smaller than ever before.

The simplex-duplex mixture duplex printing control is changed to most appropriate simplex-duplex mixture duplex printing control according to the state of sheets in a printing apparatus (image forming apparatus) or the state of simplex mixture of paper for a job to be subjected to printing from now. It tends to be difficult for the user to select simplex-duplex mixture duplex printing control most appropriate for a job to be subjected to printing from now, and, depending on the selection of simplex-duplex mixture duplex printing control, conversely, performance may be degraded. In light of such a situation, Japanese Patent Laid-Open No. 2021-184084 describes a technique which switches control described in each of Japanese U.S. Pat. No. 3,880,281 and Japanese Patent Laid-Open No. 2012-3252 according to the state of sheets in a printing apparatus or the state of simplex-duplex mixture of sheets for a job to be subjected to printing from now.

There is a case where a sheet of paper subjected to printing such as a preprinted sheet is placed in a sheet feed stage and printing is performed on such a sheet of paper. In such a case, for example, there is a case where, when a printed product is discharged, the printed product is desired to be output with a surface thereof having, for example, a logo printed thereon facing in an expected direction (upward direction or downward direction). Thus, under a situation in which printing is performed on a sheet of paper having such a property (hereinafter, also referred to as a “specific direction discharge sheet”) (thus, under a situation in which the direction of a sheet of paper is questioned), if printing on a sheet of paper or discharge of a sheet of paper to outside the apparatus is not performed with the direction of the sheet of paper aligned with the user's intended direction, a printed product which the user has expected may not be obtained. Particularly, under such a situation in which the technique described in Japanese Patent Laid-Open No. 2021-184084 is applied, if switching of the conveyance control is performed according the state of sheets in a printing apparatus or the state of simplex-duplex mixture of sheets for a job to be subjected to printing from now, a printed product which the user does not intend may be obtained.

### SUMMARY

The present disclosure is directed to enabling outputting of a printed product which the user expects, while providing more appropriate performance, even under a situation in which there is a mixture of simplex printing and duplex printing.

According to an aspect of the present disclosure, a printing apparatus capable of executing a print job including a mixture of simplex printing and duplex printing includes a feeding unit configured to feed a sheet held in a predetermined sheet holding unit, a refeeding unit configured to, in a sheet conveyance path having a plurality of waiting positions for, to print an image on a second surface of a target sheet having a first surface thereof subjected to printing in duplex printing, causing the target sheet to wait, refeed the target sheet from a predetermined waiting position of the plurality of waiting positions, and a control unit configured to control execution of a print job, wherein the control unit performs a plurality of print control operations including at least a first print control operation which performs simplex printing on a sheet subjected to an instruction for simplex printing and performs duplex printing on a sheet subjected to an instruction for duplex printing and a second print control operation which applies, to a sheet subjected to an instruction for simplex printing present between a plurality of sheets subjected to an instruction for duplex printing, conveyance control equivalent to that for a sheet subjected to an instruction for duplex printing in such a way as to cause the sheet subjected to an instruction for simplex printing to be conveyed through a conveyance path for duplex printing of the sheet conveyance path after simplex printing, while selectively switching between the plurality of print control operations based on a printing order of simplex printing and duplex printing in a target print job, a number of the plurality of waiting positions, and a number of sheets for at least any one of simplex printing and duplex printing of sheets waiting to be fed, and, wherein, in a case where, in sheets targeted for feeding, a predetermined sheet designated in such a manner that, when being discharged, a predetermined surface thereof faces in a predetermined direction is included, the control unit restricts application of the second print control operation.

Features of the present disclosure will become apparent from the following description of embodiments with reference to the attached drawings. The following description of embodiments is described by way of example.

### BRIEF DESCRIPTION OF THE DRAWINGS

FIG. 1 is a diagram illustrating an example of a system configuration of a printing system including an image forming apparatus.

FIG. 2 is a diagram illustrating an example of a configuration of the image forming apparatus.

FIG. 3 is a diagram illustrating an example of a configuration of a control unit of the image forming apparatus.

FIG. 4 is a diagram illustrating an example of a path for conveying print media in the image forming apparatus.

FIGS. 5A, 5B, and 5C are diagrams illustrating examples of directions on the conveyance path for a specific direction discharge sheet.

FIGS. 6A, 6B, 6C, and 6D are diagrams illustrating examples of sheet attribute setting screens and sheet setting screens.

FIGS. 7A and 7B are diagrams illustrating an example of duplex circulation control.

FIGS. 8A and 8B are diagrams illustrating an example of conveyance control in the image forming apparatus.

FIGS. 9A and 9B are diagrams illustrating an example of conveyance control in the image forming apparatus.

FIGS. 10A and 10B are diagrams illustrating an example of conveyance control in the image forming apparatus.

FIG. 11 is a flowchart illustrating an example of processing which is performed in the image forming apparatus.

FIGS. 12A, 12B, 12C, and 12D are diagrams illustrating examples of duplex circulation control.

FIGS. 13A and 13B are diagrams illustrating an example of conveyance control in the image forming apparatus.

FIG. 14 is a diagram illustrating an example of conveyance control in the image forming apparatus.

FIG. 15 is a flowchart illustrating an example of processing which is performed in the image forming apparatus.

FIGS. 16A, 16B, and 16C are diagrams illustrating examples of conveyance control in the image forming apparatus.

FIGS. 17A, 17B, and 17C are diagrams illustrating examples of conveyance control in the image forming apparatus.

FIGS. 18A, 18B, and 18C are diagrams illustrating examples of conveyance control in the image forming apparatus.

FIGS. 19A, 19B, and 19C are diagrams illustrating examples of conveyance control in the image forming apparatus.

FIGS. 20A and 20B are flowcharts illustrating an example of processing which is performed in the image forming apparatus.

### DESCRIPTION OF THE EMBODIMENTS

Various embodiments, features, and aspects of the present disclosure will be described in detail below with reference to the drawings.

Furthermore, in the present specification and drawings, constituent elements having the substantially same functional configuration are assigned the respective same reference characters, so that any duplicated description is omitted.

Moreover, a specific direction discharge sheet (predetermined sheet) is assumed to refer to a sheet of paper (print medium) which has been designated (restricted) by, for example, setting in such a manner that, when the sheet is discharged from an image forming apparatus, a predetermined side (obverse side or reverse side) thereof faces in a predetermined direction (upward direction or downward direction). Furthermore, the upward direction in this case is assumed to represent, for example, a direction in which printed products are progressively stacked on a sheet discharge tray (the vertically upward direction on the upper surface of the sheet discharge tray). Moreover, the downward direction is assumed to represent a direction opposite to the upward direction, i.e., a direction opposite to the direction in which printed products are progressively stacked on the sheet discharge tray (a direction headed to the sheet discharge tray as viewed from printed products).

### First Embodiment

A first embodiment of the present disclosure is described as follows.

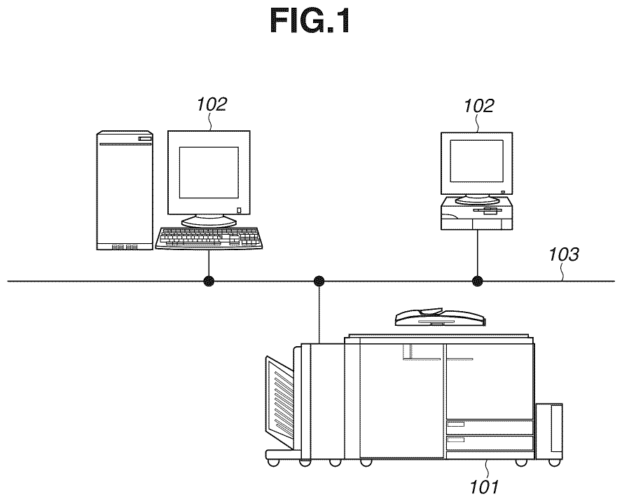

First, an example of a system configuration of a printing system including a printing apparatus (image forming apparatus) 101 according to the first embodiment of the present disclosure is described with reference to FIG. 1.

The printing system includes a host computer 102, which is configured to transmit print data to the image forming apparatus 101 according to the first embodiment of the present disclosure. The host computer 102 includes, besides the function of transmitting a print job including print data, a function which causes an image processing application to run to perform image editing processing.

The printing system further includes a network 103, which electronically interconnects the image forming apparatus 101 and the host computer 102. The image forming apparatus 101 performs communication with the host computer 102 via the network 103.

In the printing system according to the first embodiment, the image forming apparatus 101 performs formation of an image using print data received from the host computer 102.

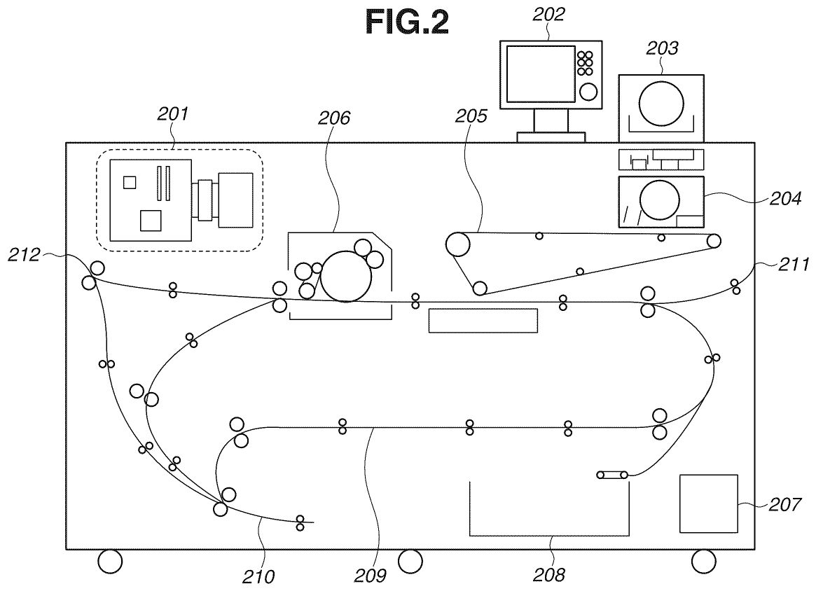

An example of a configuration of the image forming apparatus 101 according to the first embodiment is described with reference to FIG. 2.

The image forming apparatus 101 includes a control unit 201, which causes software for performing various control operations of the image forming apparatus 101 to run.

The image forming apparatus 101 further includes an operation unit 202, which is used to issue an instruction for operation to the image forming apparatus 101.

The image forming apparatus 101 further includes a toner supply unit 203, which is configured to supply toner serving as an example of printing agent to an image forming unit 204 of the image forming apparatus 101. The toner supply unit 203 is equipped with an opening and closing door, so that the operator is allowed to supply toner via the opening and closing door.

The image forming apparatus 101 further includes the image forming unit 204. The image forming unit 204 performs processing for forming an image subjected to an instruction with print data with use of toner supplied from the toner supply unit 203 and transferring the image to an intermediate transfer belt 205.

The image forming apparatus 101 further includes the intermediate transfer belt 205. The image transferred to the intermediate transfer belt 205 is transferred to a print medium such as a sheet or paper.

The image forming apparatus 101 further includes a fixing device 206. The fixing device 206 applies heat and pressure to a print medium with an image transferred thereto by the intermediate transfer belt 205, thus fixing the toner image to the print medium.

The image forming apparatus 101 further includes a surplus toner recovery unit 207. Toner which has not been transferred to the print medium in the intermediate transfer belt 205 is accumulated in the surplus toner recovery unit 207.

The image forming apparatus 101 further includes a sheet feed device (an example of a sheet holding unit) 208, which feeds print media.

The image forming apparatus 101 further includes a sheet conveyance portion 209. A print medium fed from the sheet feed device 208 passes through the sheet conveyance unit 209 and is thus subjected to transfer and fixing processing of toner.

The image forming apparatus 101 further includes a switchback portion 210, which is used to reverse the direction of a print medium.

The image forming apparatus 101 further includes a print medium insertion port 211, via which to insert a print medium from an external sheet feed device.

The image forming apparatus 101 further includes a print medium discharge portion 212, which is used to discharge a print medium subjected to fixing processing to an external output device.

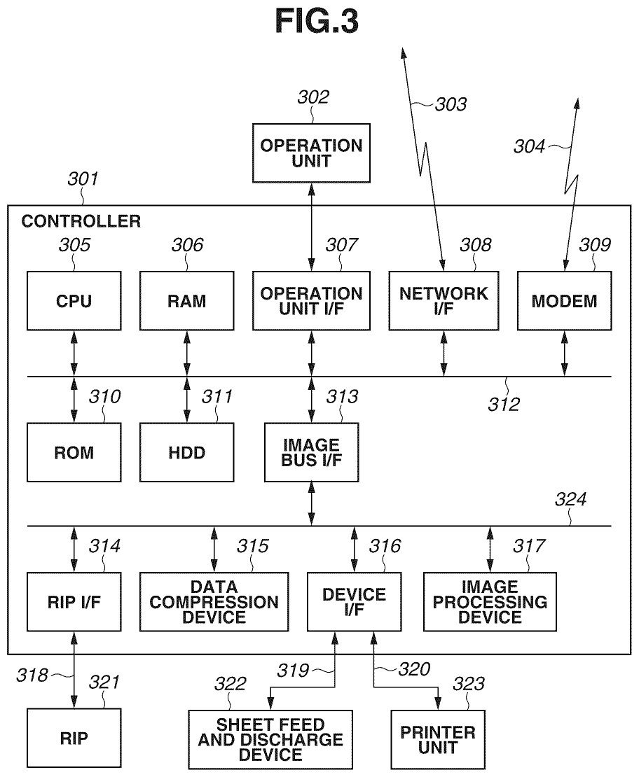

An example of a configuration of the control unit 201 of the image forming apparatus 101 is described with reference to FIG. 3.

The control unit 201 of the image forming apparatus 101 includes an overall configuration (controller) 301.

The controller 301 is connected to an operation unit 302, which is used to accept an operation from the user to the image forming apparatus 101.

A network cable 303 is used to connect the image forming apparatus 101 to external equipment via a network.

A line cable 304 is used to connect the image forming apparatus 101 to external equipment via a telephone line.

The controller 301 includes a central processing unit (CPU) 305, which controls the entire controller 301.

The controller 301 further includes a random access memory (RAM) 306, which is managed by a program running on the CPU 305. The RAM 306 is used for the purpose of, for example, a receive buffer for temporarily storing externally received data or an image data buffer for temporarily storing image data rasterized by a raster image processor (RIP).

The controller 301 further includes an interface 307, which is used to interconnect the operation unit 302 and the control unit 201.

The controller 301 further includes an interface 308, which is used to connect the control unit 201 to a network via the network cable 303.

The controller 301 further includes an interface 309, which is used to connect the control unit 201 to the telephone line 304.

The controller 301 further includes a read-only memory (ROM) 310, which stores, for example, programs running on the CPU 305 and data.

The controller 301 further includes a hard disk drive (HDD) 311, which is a non-volatile storage device capable of storing various pieces of data on a long-term basis.

The controller 301 further includes a CPU bus 312. The respective constituent elements 305 to 311 are interconnected via the CPU bus 312 in such a way as to be able to transmit and receive data with respect to one another.

The controller 301 further includes an image bus 324, which is connected to a hardware group for performing image processing.

The controller 301 further includes an interface 313, which is used to interconnect the CPU bus 312 and the image bus 324.

The controller 301 is connected to a rasterizer board (raster image processor (RIP)) 321, which has the function of converting externally input image description data into bitmapped image data.

The controller 301 further includes an interface 314, which interconnects the RIP 321 and the image bus 324 via an image transfer bus 318.

The controller 301 further includes a data compression device 315, which compresses data.

The controller 301 is connected to a sheet feed and discharge device 322.

The controller 301 is connected to a printer unit 323. With regard to a configuration of the printer unit 323, for example, the configuration illustrated as an example in FIG. 2 can be applied.

The controller 301 further includes an interface 316, which connects the printer unit 323 and the sheet feed and discharge device 322 to the image bus 324 via a data bus 319 and a data bus 320.

The controller 301 further includes an image processing device 317, which applies various pieces of image processing to bitmapped image data generated by the RIP 321. The image processing device 317 includes the function of digitally processing bitmapped image data, such as the function of integrating bitmapped image data for two pages into bitmapped image data for one page.

The CPU 305 issues a command for performing printing to the printer unit 323 and the sheet feed and discharge device 322 via the data bus 319 and the data bus 320 according to an instruction accepted by the operation unit 302 or an instruction indicated by a signal transmitted from external equipment via the network cable 303. This command causes the printer unit 323 and the sheet feed and discharge device 322 to perform printing.

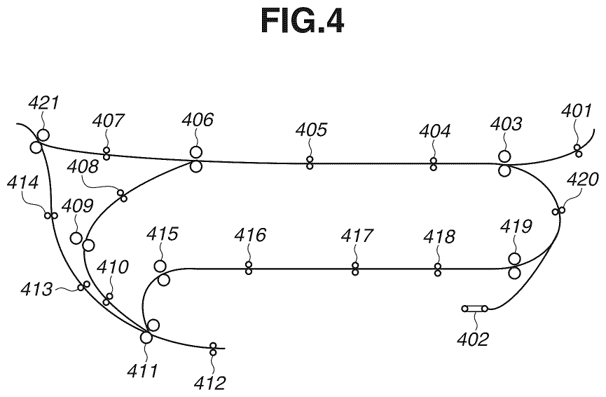

An example of a print medium conveyance path for conveying a print medium in the image forming apparatus 101 is described with reference to FIG. 4.

The print medium conveyance path includes a receiving opening 401 for putting a print medium received from an external device in the print medium conveyance path.

The print medium conveyance path further includes a receiving opening 402 for putting a print medium received from the sheet feed device 208 in the print medium conveyance path.

The print medium conveyance path further includes a discharge opening 421 for discharging a print medium from the print medium conveyance path to an external device.

The print medium conveyance path further includes print medium conveyance rollers 403 to 420 provided on the print medium conveyance path for conveying a print medium. Each of the print medium conveyance rollers 403 to 420 is independently controlled for operation according to the operation of the print medium conveyance path.

First, a case where printing is performed on only one side of a print medium and the print medium is discharged with the one side subjected to printing faced up is described. In this case, operations of the print medium conveyance rollers 403, 404, 405, 406, 407, and 421 are controlled in this order to convey the print medium.

Next, a case where printing is performed on only one side of a print medium and the print medium is discharged with the one side subjected to printing faced down is described. In this case, operations of the print medium conveyance rollers 403, 404, 405, 406, 408, 409, 410, 411, 412, 411, 413, 414, and 421 are controlled in this order to convey the print medium.

Next, a case where printing is performed on both sides of a print medium is described. In this case, operations of the print medium conveyance rollers 403, 404, 405, 406, 408, 409, and 410 are controlled in this order to convey the print medium. Then, operations of the print medium conveyance rollers 411, 412, 411, 415, 416, 417, 418, 419, 420, 403, 404, 405, 406, 407, and 421 are controlled in this order to convey the print medium.

Furthermore, a conveyance path including the print medium conveyance rollers 411 and 412 is a portion for performing switchback of a print medium, so that there is a case where control for reversing the rotations of the print medium conveyance rollers 411 and 412 is applied. Moreover, each of the print medium conveyance rollers 406 and 411 is equipped with a mechanism for switching a sheet conveyance path for conveying a print medium.

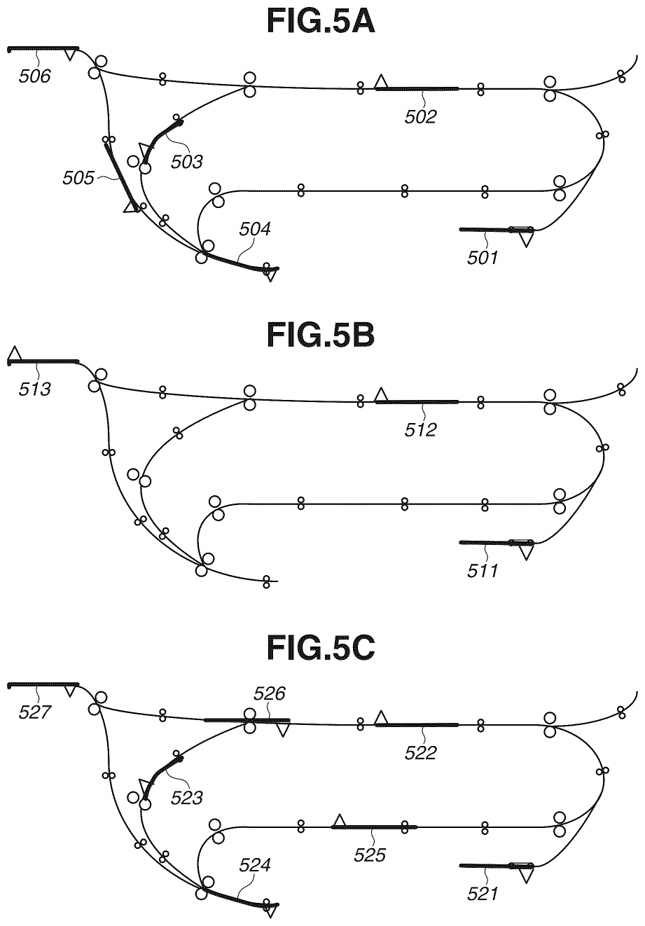

Next, examples of directions of a specific direction discharge sheet are described with reference to FIGS. 5A, 5B, and 5C.

FIG. 5A illustrates a case where printing is performed on one side of a specific direction discharge sheet and the specific direction discharge sheet is discharged with the one side subjected to printing faced down, with respect to the conveyance path illustrated in FIG. 4. In the example illustrated in FIG. 5A, a specific direction discharge sheet 501 which has been set faced down in a sheet feed stage (mark “Δ” indicating the facing direction of the specific direction discharge sheet 501) is sequentially conveyed through positions 502, 503, and 504 in this order. From there, the specific direction discharge sheet 501 is reversed, is then conveyed through positions 505 and 506, and is discharged to outside the apparatus with the sheet facing direction faced down.

FIG. 5B illustrates a case where printing is performed on one side of a specific direction discharge sheet and the specific direction discharge sheet is discharged without being reversed, with respect to the conveyance path illustrated in FIG. 4. A specific direction discharge sheet 511 which has been set faced down in a sheet feed stage (mark “Δ” indicating the facing direction of the specific direction discharge sheet 511) is sequentially conveyed through positions 512 and 513 in this order and is then discharged to outside the apparatus with the sheet facing direction faced up.

FIG. 5C illustrates a case where duplex printing is performed on both sides of a specific direction discharge sheet, with respect to the conveyance path illustrated in FIG. 4. A specific direction discharge sheet 521 which has been set faced down in a sheet feed stage (mark “Δ” indicating the facing direction of the specific direction discharge sheet 521) is sequentially conveyed through positions 522, 523, and 524 in this order, is reversed from there, is then sequentially conveyed through positions 525, 526, and 527 in this order, and is discharged to outside the apparatus with the sheet facing direction faced down.

Thus, in comparison between the case where printing is performed on one side of a specific direction discharge sheet and the specific direction discharge sheet is discharged without being reversed, illustrated in FIG. 5B, and the case where printing is performed on both sides of a specific direction discharge sheet, illustrated in FIG. 5C, although the specific direction discharge sheets are set in the same direction in the sheet feed stage, the respective directions of printed products become opposite each other. Moreover, in comparison between the case where printing is performed on one side of a specific direction discharge sheet and the specific direction discharge sheet is discharged without being reversed, illustrated in FIG. 5B, and the case where printing is performed on one side of a specific direction discharge sheet and the specific direction discharge sheet is discharged with the one side subjected to printing faced down, illustrated in FIG. 5A, similarly, although the specific direction discharge sheets are set in the same direction in the sheet feed stage, the respective directions of printed products become opposite each other.

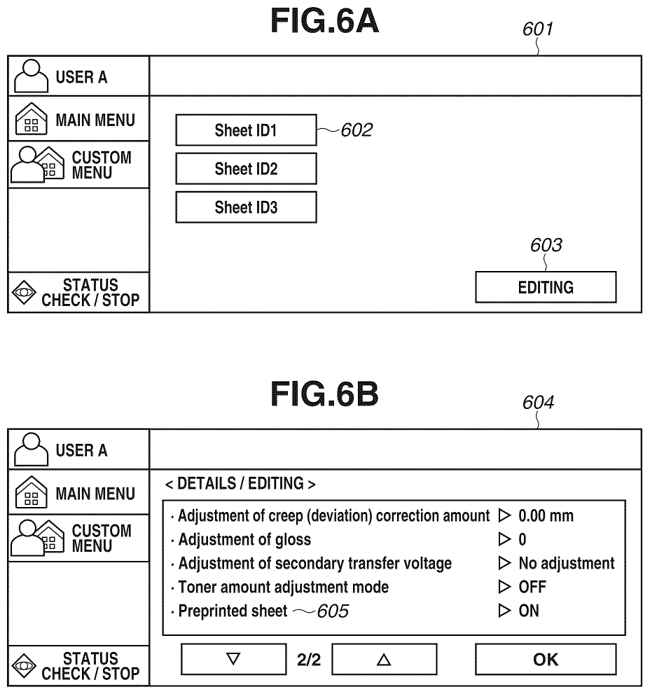

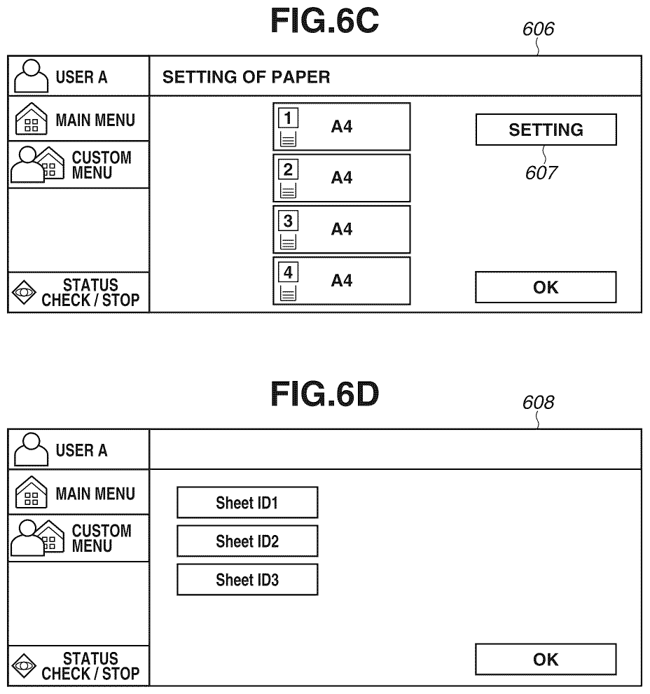

Next, examples of sheet attribute setting screens and sheet setting screens are described with reference to FIGS. 6A, 6B, 6C, and 6D. Each of the screens illustrated in FIGS. 6A to 6D is a screen which is displayed on the operation unit 302 illustrated in FIG. 3. Specifically, FIG. 6A illustrates an example of a sheet attribute editing screen 601. In the sheet attribute editing screen 601, a series of sheet identifiers (IDs) serving as candidates for editing targets is presented in such a manner that each sheet ID is selectable, and, in response to an editing button 603 being pressed with any candidate selected, a sheet attribute setting screen 604 illustrated in FIG. 6B is displayed. Here, it is assumed that “sheet ID1”602 has been selected and the editing button 603 has been pressed.

In the sheet attribute setting screen 604, the values of attributes of each sheet are allowed to be changed. A preprinted sheet attribute 605 is an attribute for indicating that the sheet is, unlike an ordinary white sheet of paper, a sheet the direction of the surface of which is important.

A sheet setting screen 606 illustrated in FIG. 6C is an example of a screen for setting the type of a sheet for a sheet feed stage. In the sheet setting screen 606, the current settings for the respective sheet feed stages are displayed. Moreover, in response to a sheet ID setting button 607 being pressed, a sheet ID list screen 608 illustrated in FIG. 6D is displayed. In the sheet ID list screen 608, a list of sheet IDs subjected to editing in the sheet attribute editing screen 601 is displayed. In response to a sheet ID being selected in the sheet ID list screen 608, the selected sheet ID is set to a target sheet feed stage.

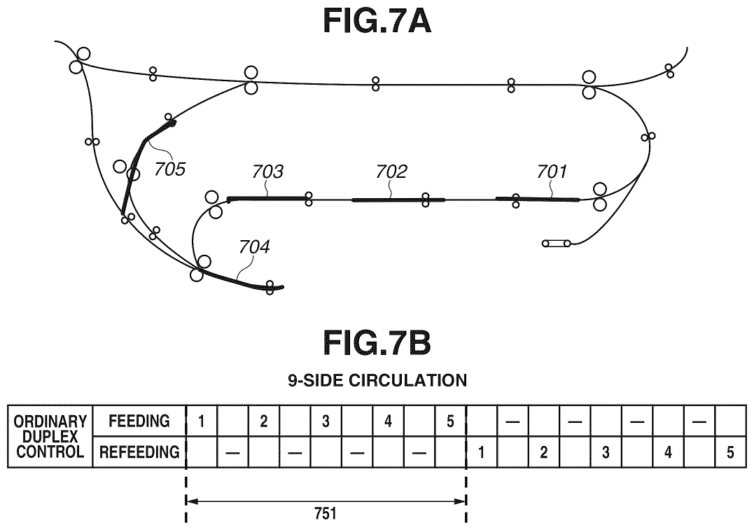

Duplex circulation control is described with reference to FIGS. 7A and 7B. FIG. 7A is a schematic diagram of a conveyance path for use in duplex printing, and illustrates waiting positions of sheets which are waiting to be refed. FIG. 7B shows a sheet feeding order for 9-side circulation in which five sheets are waiting to be refed as illustrated in FIG. 7A.

Specifically, FIG. 7A is a diagram illustrating a state in which print media are simultaneously present on the above-mentioned conveyance path. A plurality of waiting positions is present on the conveyance path, including print medium waiting positions 701 to 705. The example illustrated in FIG. 7A represents a situation in which the print media illustrated as situated in the respective waiting positions 701 to 705 have already been subjected to printing on the respective obverse sides of the print media and are waiting to be subjected to printing on the respective reverse sides of the print media. When an operation for duplex printing is performed, feeding for performing obverse side printing from the receiving opening 401 or 402 and refeeding for performing reverse side printing are alternately performed to improve productivity.

FIG. 7B is a diagram illustrating an output order of feeding and refeeding at the time of duplex printing for five sheets of paper. As illustrated in FIG. 7A, in the conveyance path included in the image forming apparatus 101, it is possible to cause sheets for five sides to wait in the waiting positions 701 to 705 for refeeding. Therefore, for example, feeding for five sides is performed in advance and, after that, refeeding of the sheets which have been caused to wait in the waiting positions 701 to 705 is performed. Such waiting positions for refeeding are determined by the length and mechanical configuration of the conveyance path in the image forming apparatus 101. The example illustrated in FIG. 7B is called “9-side circulation”, because the number of sides present until the sheets which have been fed become able to be refed is nine as denoted by a two-headed arrow 751.

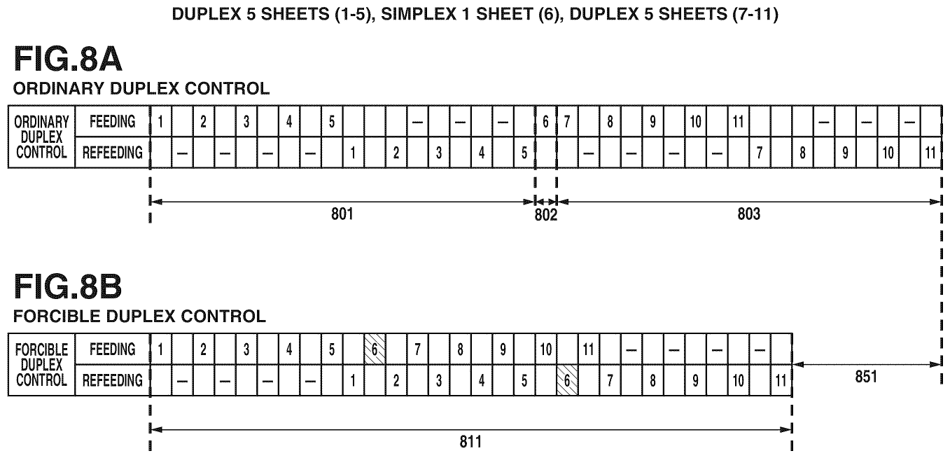

FIGS. 8A and 8B are explanatory diagrams used to explain an example of conveyance control in the image forming apparatus 101 according to the first embodiment, and illustrates a difference between ordinary duplex control and forcible duplex control. Furthermore, in the following description, for the sake of convenience, “sheet (print medium) designated for simplex printing” is sometimes referred to simply as “simplex” and “sheet (print medium) designated for duplex printing” is sometimes referred to simply as “duplex”. For example, the description “duplex 5 sheets” is assumed to indicate that the number of sheets designated for duplex printing is five, and the description “simplex 1 sheet” is assumed to indicate that the number of sheets designated for simplex printing is one. The example illustrated in FIGS. 8A and 8B represents an example of a case where printing is performed with respect to duplex 5 sheets (1-5), simplex 1 sheet (6), and duplex 5 sheets (7-11).

FIG. 8A is a diagram illustrating an example of control called “ordinary duplex control”. The ordinary duplex control is a control method which performs conveyance control for duplex printing with respect to a sheet for duplex printing and performs conveyance control for simplex printing with respect to a sheet for simplex printing. Thus, with regard to duplex printing, a print medium is conveyed through the print medium conveyance rollers 403, 404, 405, 406, 408, 409, 410, 411, 412, 411, 415, 416, 417, 418, 419, and 420 illustrated in FIG. 4 in this order. Then, the print medium is conveyed through the print medium conveyance rollers 403, 404, 405, 406, 407, and 421 illustrated in FIG. 4 in this order. Moreover, with regard to simplex printing, a print medium is conveyed through the print medium conveyance rollers 403, 404, 405, 406, 407, and 421 illustrated in FIG. 4 in this order or the print medium conveyance rollers 403, 404, 405, 406, 408, 409, 410, 411, 412, 411, 413, 414, and 421 illustrated in FIG. 4 in this order.

As illustrated in FIG. 8A, in a printing range 801, duplex printing control is performed and refeeding for all of the sheets is performed in preparation for simplex printing in a printing range 802, and, then, simplex printing is subsequently performed. After simplex printing has been performed in the printing range 802, to perform next duplex printing, duplex printing control is performed again in a printing range 803.

In this way, in the ordinary duplex control, when duplex printing is switched to simplex printing, such switching is performed after refeeding for all of the sheets for duplex printing is once completed. In the following description, such a switching operation is also referred to as “duplex circulation being cut out”.

FIG. 8B is a diagram illustrating an example of control called “forcible duplex control”. The forcible duplex control is conveyance control which, even for a sheet for simplex printing, performs duplex printing while making the reverse side of the sheet white. In the example illustrated in FIG. 8B, although the sixth sheet is a sheet for simplex printing, duplex printing is performed with the reverse side of the sixth sheet made white.

In FIG. 8B, the sixth sheet is denoted by hatching. Applying this control method enables, in a printing range 811, continuing duplex circulation control with respect to all of the sheets. Therefore, the case where forcible duplex control is applied looks more promising an improvement in performance by the number of sides indicated by a range 851 than the case where ordinary duplex control is applied.

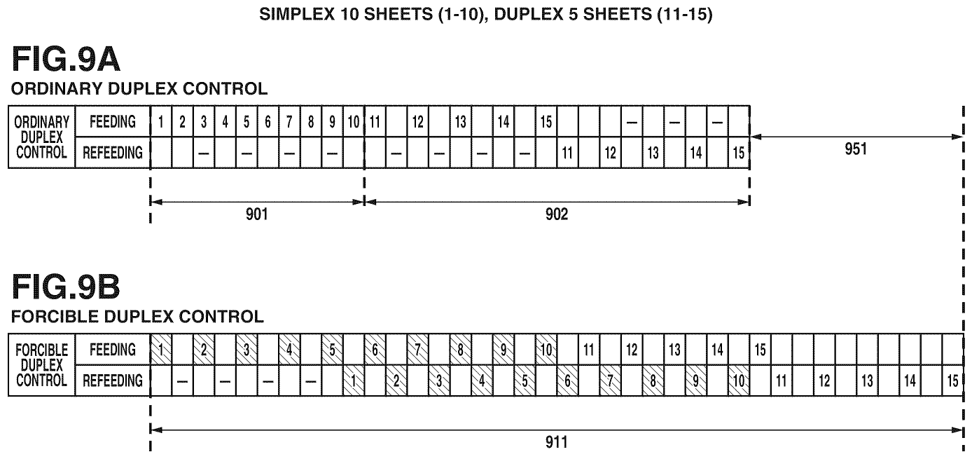

FIGS. 9A and 9B are explanatory diagrams used to explain another example of conveyance control which is performed in the image forming apparatus 101 according to the first embodiment. The example illustrated in FIGS. 9A and 9B represents an example of a case where ordinary duplex control and forcible duplex control are applied with respect to simplex 10 sheets (1-10) and duplex 5 sheets (11-15). Forcible duplex control has been described above with reference to FIGS. 8A and 8B and, therefore, the detailed description thereof is omitted here.

FIG. 9A illustrates an example of the case where ordinary duplex control has been applied. In the example illustrated in FIG. 9A, feeding for simplex 10 sheets (1-10) is performed in a printing range 901 and duplex 5 sheets (11-15) are fed by 9-side circulation (feeding for five sheets is performed in advance) in a printing range 902.

FIG. 9B illustrates an example of the case where forcible duplex control has been applied. In the example illustrated in FIG. 9B, printing is performed with simplex 10 sheets (1-10) caused to pass through a duplex conveyance path, so that, in a printing range 911, duplex printing control using 9-side circulation with simplex 10 sheets (1-10) and duplex 5 sheets (11-15) made continuous is performed.

Forcible duplex control continues duplex circulation by causing a sheet for simplex printing situated between a sheet bundle for duplex printing to pass through a duplex conveyance path and thus aims to improve performance. On the other hand, in a case where, as in the example illustrated in FIGS. 9A and 9B, there are no preceding sheets for duplex printing, rather, sheets for simplex printing are excessively caused to pass through a duplex conveyance path, so that performance may degrade. Therefore, the example illustrated in FIGS. 9A and 9B makes it understood that feeding for ordinary duplex control is completed earlier by 10 sides (a period of time indicated by a range 951) than feeding for forcible duplex control.

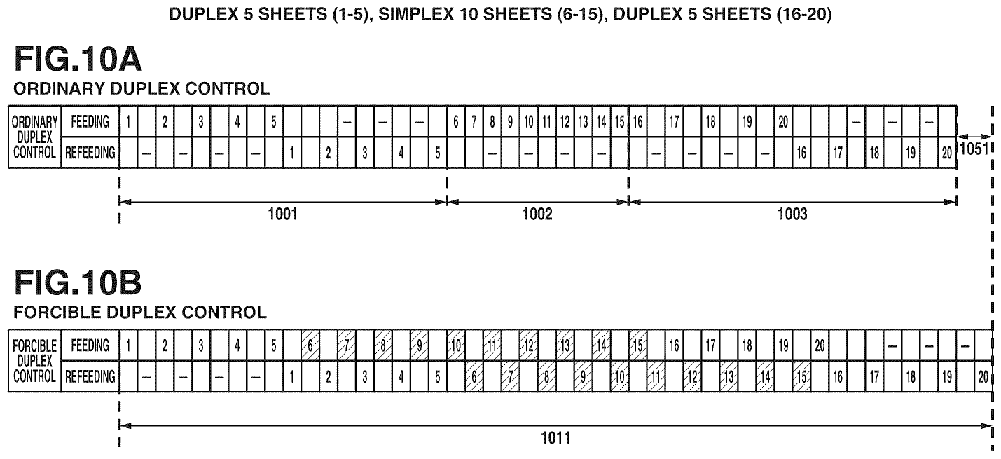

FIGS. 10A and 10B are explanatory diagrams used to explain yet another example of conveyance control which is performed in the image forming apparatus 101 according to the first embodiment. The example illustrated in FIGS. 10A and 10B represents an example of a case where ordinary duplex control and forcible duplex control are applied with respect to duplex 5 sheets (1-5), simplex 10 sheets (6-15), and duplex 5 sheets (16-20).

FIG. 10A illustrates an example of the case where ordinary duplex control has been applied. In the example illustrated in FIG. 10A, in a printing range 1001, duplex printing using 9-side circulation is performed with respect to duplex 5 sheets (1-5). Moreover, in a printing range 1002, feeding for simplex 10 sheets (6-15) is performed, and, in a printing range 1003, duplex printing using 9-side circulation is performed with respect to duplex 5 sheets (16-20).

FIG. 10B illustrates an example of the case where forcible duplex control has been applied. In the example illustrated in FIG. 10B, printing is performed with simplex 10 sheets (6-15) caused to pass through a duplex conveyance path, so that, in a printing range 1011, duplex printing control using 9-side circulation with duplex 5 sheets (1-5), simplex 10 sheets (6-15), and duplex 5 sheets (16-20) made continuous is performed.

As understood by comparing FIG. 10A and FIG. 10B with each other, in the example illustrated in FIGS. 10A and 10B, the case where ordinary duplex control is better in performance by two sides indicated by a range 1051 than the case where forcible duplex control is applied.

In the above description of the example illustrated in FIGS. 8A and 8B, forcible duplex control continues duplex circulation by causing a sheet for simplex printing situated between a sheet bundle for duplex printing to pass through a duplex conveyance path and thus aims to improve performance. On the other hand, even in a case where, as in the example illustrated in FIGS. 10A and 10B, sheets for simplex printing are present between a sheet bundle for duplex printing, under a situation in which the quantity of sheets for simplex printing present between a sheet bundle for duplex printing is relatively large, disadvantages brought about by forcibly causing sheets for simplex printing to pass through a duplex conveyance path may become larger rather than the expected advantages.

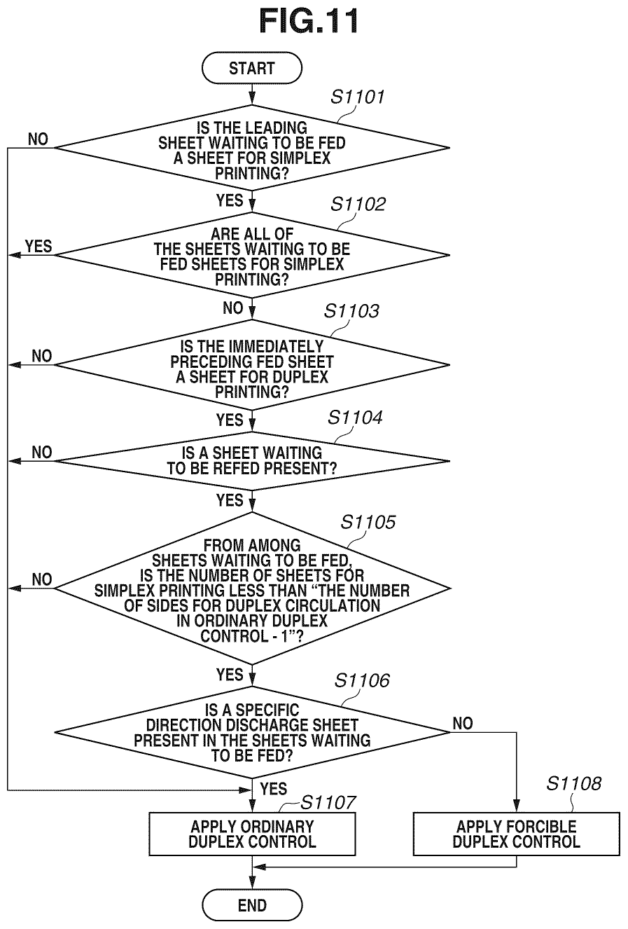

Next, an example of processing which is performed in the image forming apparatus 101 according to the first embodiment is described with reference to FIG. 11, particularly, with a focus put on processing concerning switching between ordinary duplex control and forcible duplex control.

In step S1101, the CPU 305 determines whether the leading sheet on a feed waiting sheet queue retained in the RAM 306 is a sheet for simplex printing.

If, in step S1101, it is determined that the leading sheet is a sheet for simplex printing (YES in step S1101), the CPU 305 advances the processing to step S1102, and, if is determined that the leading sheet is a sheet for duplex printing (NO in step S1101), the CPU 305 advances the processing to step S1107. Furthermore, in a case where the leading sheet on the feed waiting sheet queue is a sheet for duplex printing, since both sides thereof are already targeted for conveyance, it becomes difficult to perform control for causing a sheet for simplex printing to pass through a duplex conveyance path, such as forcible duplex control. Therefore, in that case, in step S1107, the CPU 305 applies ordinary duplex control.

In step S1102, the CPU 305 determines whether all of the sheets waiting to be fed are sheets for simplex printing.

If, in step S1102, it is determined that all of the sheets are sheets for simplex printing (YES in step S1102), the CPU 305 advances the processing to step S1107, and, if it is determined that not all of the sheets are sheets for simplex printing (at least one sheet is a sheet for duplex printing) (NO in step S1102), the CPU 305 advances the processing to step S1103. Furthermore, in a case where all of the sheets are sheets for simplex printing, since the job is not in the state of including a mixture of simplex printing and duplex printing, the CPU 305 determines that control for improving performance during a mixture of simplex printing and duplex printing, such as forcible duplex control, itself becomes meaningless. Therefore, in that case, in step S1107, the CPU 305 applies ordinary duplex control and thus performs simplex printing for sheets for simplex printing.

In step S1103, the CPU 305 determines whether the immediately preceding fed sheet is a sheet for duplex printing.

If, in step S1103, it is determined that the immediately preceding fed sheet is a sheet for duplex printing (YES in step S1103), the CPU 305 advances the processing to step S1104, and, if it is determined that the immediately preceding fed sheet is not a sheet for duplex printing (is a sheet for simplex printing) (NO in step S1103), the CPU 305 advances the processing to step S1107. Forcible duplex control, which continues duplex circulation following an already fed sheet bundle for duplex printing, is not possible in a case where the immediately preceding fed sheet is a sheet for simplex printing. Therefore, in a case where the immediately preceding fed sheet is a sheet for simplex printing, the CPU 305 does not apply forcible duplex control but applies ordinary duplex control in step S1107. Furthermore, the effect that applying forcible duplex control in a case where the immediately preceding fed sheet is a sheet for simplex printing brings disadvantages is as described above with reference to FIGS. 9A and 9B.

In step S1104, the CPU 305 determines whether a sheet waiting to be refed is present.

If, in step S1104, it is determined that a sheet waiting to be refed is present (YES in step S1104), the CPU 305 advances the processing to step S1105, and, if it is determined that no sheet waiting to be refed is present (NO in step S1104), the CPU 305 advances the processing to step S1107. Furthermore, in a case where the immediately preceding fed sheet is not a sheet waiting to be refed for duplex printing, the immediately preceding fed sheet is in the state of having already been discharged as a sheet for duplex printing to outside the apparatus. Forcible duplex control is control which continues duplex circulation following an already fed sheet bundle for duplex printing and is, therefore, not possible in the state in which no sheet waiting to be refed is present and duplex circulation is cut out. Therefore, in a case where no sheet waiting to be refed is present, the CPU 305 does not apply forcible duplex control but applies ordinary duplex control in step S1107.

In step S1105, the CPU 305 determines whether, from among sheets waiting to be fed, the number of sheets for simplex printing is less than “the number of sides for duplex circulation in ordinary duplex control—1”.

If, in step S1105, it is determined that the number of sheets for simplex printing is less than “the number of sides for duplex circulation in ordinary duplex control—1” (YES in step S1105), the CPU 305 advances the processing to step S1106, and, if it is determined that the number of sheets for simplex printing is greater than or equal to “the number of sides for duplex circulation in ordinary duplex control—1” (NO in step S1105), the CPU 305 advances the processing to step S1107. Furthermore, in a case where a sheet bundle for duplex printing, a sheet bundle for simplex printing, and a sheet bundle for duplex printing have been made continuous in this order, if the number of sheets in the sheet bundle for simplex printing is large (is greater than or equal to “the number of sides for duplex circulation in ordinary duplex control—1”), the case where forcible duplex control has been applied brings more disadvantages in performance than the case where ordinary duplex control has been applied. Therefore, the CPU 305 restricts applying forcible duplex control and applies ordinary duplex control. Furthermore, the decrease in performance caused by the application of forcible duplex control in this case is as described above with reference to FIGS. 10A and 10B.

In step S1106, the CPU 305 determines whether a specific direction discharge sheet is present in the sheets waiting to be fed.

If, in step S1106, it is determined that a specific direction discharge sheet is present in the sheets waiting to be fed (YES in step S1106), the CPU 305 advances the processing to step S1107, and, if it is determined that no specific direction discharge sheet is present in the sheets waiting to be fed (NO in step S1106), the CPU 305 advances the processing to step S1108.

Furthermore, as mentioned above with reference to FIGS. 5A to 5C, if the control to be applied to a specific direction discharge sheet is changed from simplex printing to duplex printing, the direction of the specific direction discharge sheet is changed, so that it may become impossible to obtain a printed product which the user has expected. Therefore, in a case where a specific direction discharge sheet is present in the sheets waiting to be fed, the CPU 305 does not apply forcible duplex control but applies ordinary duplex control in step S1107.

On the other hand, if, in step S1106, it is determined that no specific direction discharge sheet is present in the sheets waiting to be fed, then in step S1108, the CPU 305 applies forcible duplex control.

With the above-described control operations applied, with respect to printing including a mixture of simplex printing and duplex printing, printing control to be applied is selectively switched according to the state of the printing apparatus or the situation of a mixture of simplex printing and duplex printing to be subjected to printing from now, so that an advantageous effect of improving performance looks promising. Besides, under a situation in which a specific direction discharge sheet can be applied, it becomes possible to, while aiming at improving performance as mentioned above, cause a printed product to be output in a manner which the user expects.

### Second Embodiment

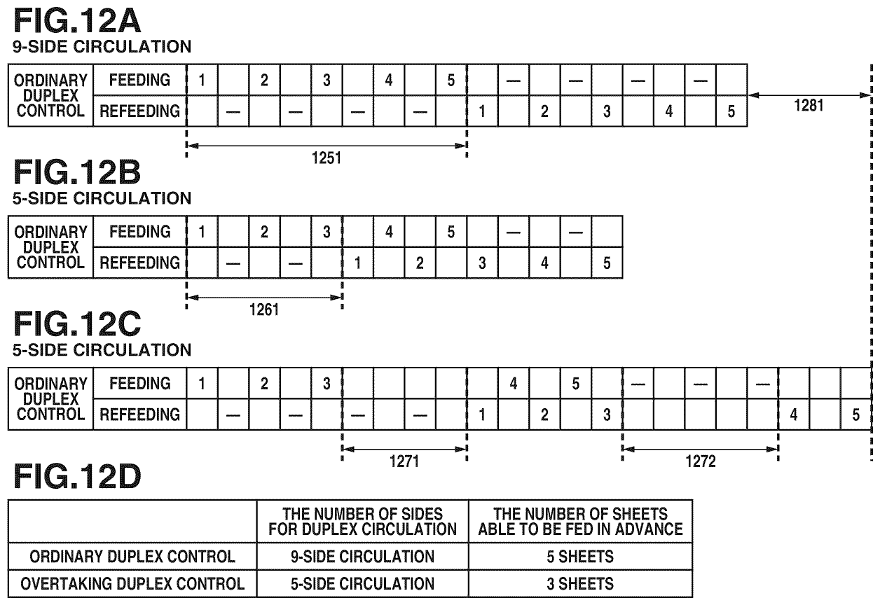

A second embodiment of the present disclosure is described as follows with reference to FIGS. 12A, 12B, 12C, and 12D to FIGS. 20A and 20B.

First, an example of duplex circulation control is described with reference to FIGS. 12A to 12D.

FIG. 12A shows a sheet feeding order for 9-side circulation in which five sheets are waiting to be refed as illustrated in FIG. 7A.

FIG. 12B, unlike FIG. 12A, shows a sheet feeding order for 5-side circulation in which three sheets are waiting to be refed.

FIG. 12C shows a sheet feeding order and a sheet interval in a case where 5-side circulation illustrated in FIG. 12B has been performed on a conveyance path for 9-side circulation illustrated in FIG. 12A.

FIG. 12D shows a relationship between the number of sheets able to be fed in advance and each of the number of sides for 9-side circulation illustrated in FIG. 12A and the number of sides for 5-side circulation illustrated in FIG. 12B.

The details of each of FIGS. 12A to 12D are described as follows.

FIG. 12A is a diagram showing an output order of feeding and refeeding at the time of duplex printing on five sheets. As explained above with reference to FIG. 7A, in the conveyance path included in the image forming apparatus 101 according to the second embodiment of the present disclosure, it is possible to cause sheets for five sides to wait in the waiting positions 701 to 705 for refeeding. Therefore, in the example illustrated in FIG. 12A, feeding for five sides is performed in advance and, after that, refeeding of the sheets which have been caused to wait in the waiting positions 701 to 705 is performed. Such waiting positions for refeeding are determined by the length and mechanical configuration of the conveyance path in the image forming apparatus 101. The example illustrated in FIG. 12A is called “9-side circulation”, because the number of sides present until the sheets which have been fed become able to be refed is nine as denoted by a two-headed arrow 1251.

Furthermore, in an apparatus model capable of performing feeding for three sheets in advance, for example, control such as that illustrated in FIG. 12B is able to be applied. The example illustrated in FIG. 12B represents a print control method which performs feeding for three sheets 1 to 3 in advance and, after that, alternately performs refeeding and feeding. The example illustrated in FIG. 12B is called “5-side circulation”, because the number of sides present until the sheets which have been fed become able to be refed is five as denoted by a two-headed arrow 1261.

FIG. 12C illustrates an example of a case where, as illustrated by example in FIGS. 7A, 5-side circulation has been performed in a conveyance path in which there are waiting positions for five sides at which to cause sheets to wait to be refed. In this case, even if feeding for three sheets is performed in advance as in 5-side circulation, since the actual conveyance path is long, sheet intervals for 9 sides become required until, after feeding is performed as with the example illustrated in FIG. 12A, the same sheet is refed. Therefore, sheet intervals appear as denoted by two-headed arrows 1271 and 1272, so that, as compared with 9-side circulation illustrated by example in FIG. 12A, performance may decrease by a period denoted by a two-headed arrow 1281 (FIG. 12A).

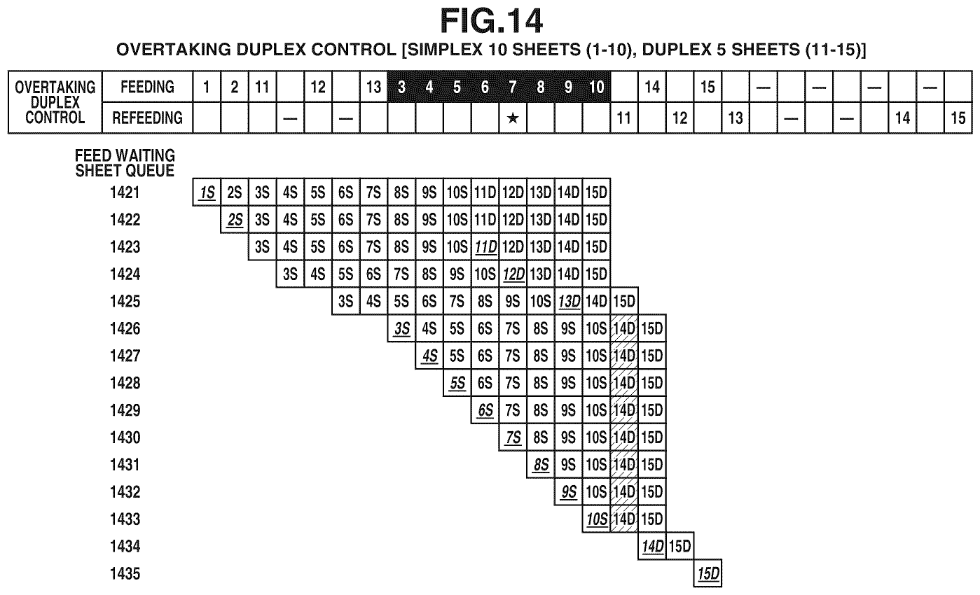

FIG. 12D illustrates an example of a relationship between the number of sides for duplex circulation and the number of sheets able to be fed in advance in the image forming apparatus 101 according to the second embodiment. In this case, “the number of sheets able to be fed in advance×2−1” becomes equivalent to the number of sides for duplex circulation. The number of sides for duplex circulation varies depending on a conveyance path in the image forming apparatus 101 or a paper size to be used for printing. Therefore, values in the example illustrated in FIG. 12D are merely examples. Moreover, in overtaking duplex control described below with reference to FIG. 14, the number of sides for duplex circulation may decrease as compared with ordinary duplex control. In an example in the second embodiment, the number of sides for duplex circulation in ordinary duplex control is nine, and the number of sides for duplex circulation in overtaking duplex control is five.

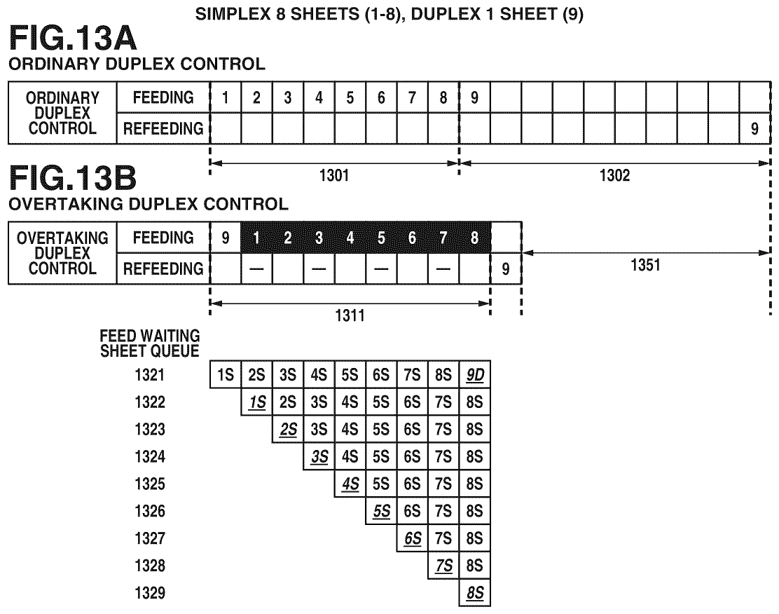

An example of conveyance control in the image forming apparatus 101 according to the second embodiment is described with reference to FIGS. 13A and 13B with a focus put on a difference between ordinary duplex control and overtaking duplex control. The example illustrated in FIGS. 13A and 13B represents an example of a case where printing has been performed with respect to eight sheets for simplex printing (1-8) and one sheet for duplex printing (9).

FIG. 13A illustrates an example of a case where ordinary duplex control has been applied. In the example illustrated in FIG. 13A, simplex printing is performed with respect to eight sheets for simplex printing in a printing range 1301 and duplex printing is performed with respect to one sheet for duplex printing in a printing range 1302. To perform duplex printing for one sheet in the printing range 1302, conveyance in a conveyance path corresponding to the duplex conveyance path illustrated in FIG. 4 is required to be performed, so that the corresponding sheet interval appears. The sheet interval which has appeared could be a factor in a decrease of performance.

FIG. 13B illustrates an example of a case where the overtaking duplex control has been applied. The overtaking duplex control is a control method which has been proposed to, since a sheet interval which has appeared from feeding until refeeding in ordinary duplex control, illustrated by way of example as a printing range 1302, could be a factor in a decrease of performance, aims at improving the decrease of performance. Thus, the overtaking duplex control is a control method which, in printing continuing as simplex printing and duplex printing in this order, overtakes simplex printing, performs printing for the fed side of a sheet for subsequent duplex printing, and performs simplex printing at a sheet interval which has appeared. In the example illustrated in FIG. 13B, the first side of a duplex printing sheet following, as the ninth sheet, the first to eighth simplex printing sheets is fed in first and then subjected to printing. Then, printing is performed with respect to sheets 1 to 8 for simplex printing, which have been overtaken, as denoted by a printing range 1311, and, after that, printing is performed with respect to the second side of the duplex printing sheet serving as the ninth sheet. In the example illustrated in FIG. 13B, sheets 1 to 8 for simplex printing, which have been overtaken, are expressed with black background. In the following description, for the sake of convenience, a sheet for simplex printing which has been overtaken by overtaking duplex control is assumed to be similarly expressed with black background in the drawings.

An example of the above-mentioned overtaking duplex control is described with use of feed waiting sheet queues 1321 to 1329. The feed waiting sheet queue is a data structure which is retained in the RAM 306 and is used to manage information about sheets to be fed from now. A Simplex printing sheet or duplex printing sheet is added to the feed waiting sheet queue in the printing order and is removed from the feed waiting sheet queue at the time point when the sheet has been fed (in the case of a duplex printing sheet, at the time point not when the second side of the sheet has been refed but when the first side of the sheet has been fed). In the feed waiting sheet queue 1321, the first to eighth sheets for simplex printing are denoted as 1S to 8S, and the ninth sheet for duplex printing is denoted as 9D. Here, “S” and “D” are suffixes representing simplex and duplex, respectively.

In the overtaking duplex control, checking whether a sheet for duplex printing is present in “the number of sides for duplex circulation—1” following the leading sheet in the feed waiting sheet queue is performed, and, if the sheet for duplex printing is present, such sheet for duplex printing is fed in first.

In the case of the feed waiting sheet queue 1321, sheets following the sheet 1S are “sheets 2S, 3S, 4S, 5S, 6S, 7S, 8S, and 9D”. Moreover, since the number of sides for duplex circulation is nine, checking whether a sheet for duplex printing is present within 9−1=8 sheets is performed. In the feed waiting sheet queue 1321, the sheet 9D is present just as the eighth sheet. Therefore, the sheet 9D is fed in advance of the sheet 1S. Furthermore, in FIG. 13B, with respect to a sheet serving as a target sheet which has become targeted for feeding in each feed waiting sheet queue, the reference character thereof is underlined and the reference character thereof is expressed in italics. Thus, in the feed waiting sheet queue 1321, since the sheet 9D is targeted for feeding, the reference character “9D” is underlined and the reference character “9D” is expressed in italics. In the feed waiting sheet queues 1322 to 1329, the leading sheets in the respective feed waiting sheet queues, i.e., sheets “1S, 2S, 3S, 4S, 5S, 6S, 7S, and 8S”are fed in sequence.

As described above, in the example illustrated in FIGS. 13A and 13B, the case where the overtaking duplex control has been applied can be more expected to improve performance by 8 sides as denoted by a two-headed arrow 1351 compared with the case where ordinary duplex control has been applied.

An example of a case where the overtaking duplex control has been applied is described with reference to FIG. 14 as another example of conveyance control which is performed in the image forming apparatus 101 according to the second embodiment. FIG. 14 illustrates an example of the case where printing has been performed with respect to 10 sheets for simplex printing (1-10) and five sheets for duplex printing (11-15) by the overtaking duplex control.

In feed waiting sheet queues 1421 and 1422, since no sheet for duplex printing is present until the eighth sheet following the sheets 1S and 2S, the sheets 1S and 2S are fed in first, respectively.

In a feed waiting sheet queue 1423, since a sheet for duplex printing is present until the eighth sheet following the sheet 3S, the subsequent sheet 11D for duplex printing is fed in first.

In a feed waiting sheet queue 1424, since the sheet 11D has been fed in the feed waiting sheet queue 1423, the sheet 11D is removed from the feed waiting sheet queue 1424, so that, as a result, a sheet 12D for duplex printing is present as the eighth sheet following the sheet 3S. Therefore, the subsequent sheet 12D for duplex printing is fed in first.

In a feed waiting sheet queue 1425, which is similar to the feed waiting sheet queue 1424, the subsequent sheet 13D for duplex printing is fed in first.

In a feed waiting sheet queue 1426, the sheet 14D for duplex printing is present until the eighth sheet following the sheet 3S. However, as explained above with reference to FIGS. 7A and 7B, since, in a case where overtaking duplex control is applied, there is a mixture of sheets for duplex printing and simplex printing, the positions usable as waiting positions for refeeding of a sheet for duplex printing are restricted to the waiting positions 701, 702, and 703. This is because there is a possibility of causing a sheet for simplex printing to pass through a conveyance path including passage through the conveyance rollers 408, 409, 410, 411, 412, 411, 413, 414, and 421. If a sheet is caused to wait at the waiting position 704 or 705 for refeeding of a sheet for duplex printing, a collision with a sheet which is reversed in simplex printing occurs, so that a jam may occur. As a result, at the time of application of overtaking duplex control, only three sheets are able to be fed in advance, so that a printing operation is performed substantially with 5-side circulation. The number of sides in duplex circulation varying between ordinary duplex control and overtaking duplex control is as described above with reference to FIG. 12D. In the feed waiting sheet queue 1426, since three sheets have already been fed in advance in the feed waiting sheet queues 1423, 1424, and 1425, it is difficult to feed any further sheets for duplex printing, so that the sheet 3S comes to be fed. In FIG. 14, the sheet 14D, with respect to which the application of overtaking duplex control has been restricted, is expressed by hatching.

In feed waiting sheet queues 1427 to 1433, as with the feed waiting sheet queue 1426, the sheet 14D for duplex printing is present until the subsequent eighth sheet, three sheets have already been fed in advance. Therefore, the leading sheets 3S, 4S, 5S, 6S, 7S, 8S, 9S, and 10S for simplex printing in the respective feed waiting sheet queues are fed in first.

In a feed waiting sheet queue 1433, after the sheet 10S for simplex printing has been fed, refeeding of the sheet 11D, which has been fed in the feed waiting sheet queue 1423 and is present at the duplex waiting position 701, is performed. Essentially, after being fed, the sheet 11D is able to be refed after 9 sides. In FIG. 14, that point is denoted by an asterisk (star marker). However, since feeding of the sheets 7S to 10S for simplex printing, which have been overtaken, is being performed, the actual timing of refeeding of the sheet 11D is after feeding of the sheet 10S.

In a feed waiting sheet queue 1434, since the number of sheets for duplex printing which have been fed in advance has become two, feeding of the sheet 14D is performed. After feeding of the sheet 14D, refeeding of the sheet 12D is performed, and, in a feed waiting sheet queue 1435, feeding of the sheet 15D is performed.

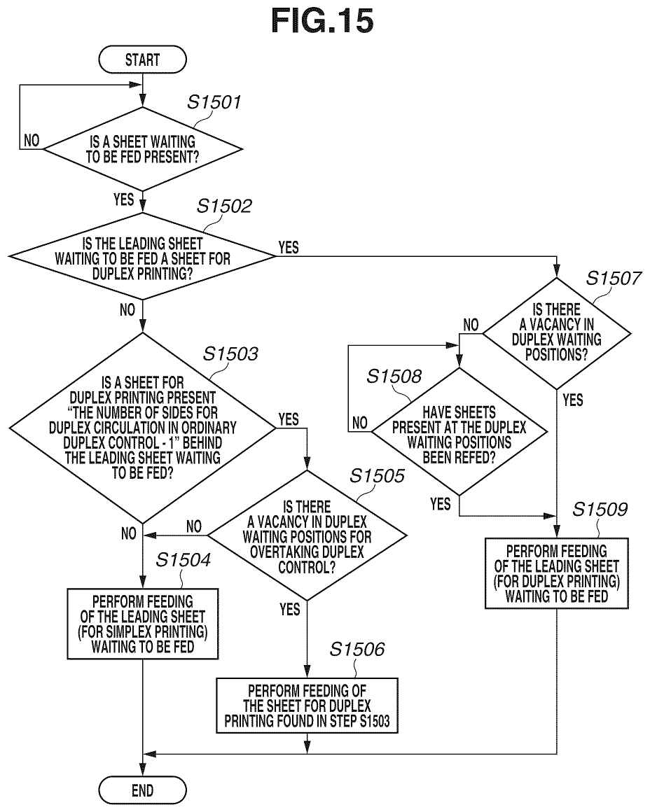

An example of processing which is performed in the image forming apparatus 101 according to the second embodiment is described with reference to FIG. 15 with a focus put on processing which is performed in a case where overtaking duplex control can be applied.

In step S1501, the CPU 305 determines whether a sheet is present on a feed waiting sheet queue retained in the RAM 306.

If, in step S1501, it is determined that no sheet is present on the feed waiting sheet queue (NO in step S1501), the CPU 305 returns the processing to step S1501, thus waiting for a sheet waiting for feeding to be newly registered. Then, if, in step S1501, it is determined that a sheet is present on the feed waiting sheet queue (YES in step S1501), the CPU 305 advances the processing to step S1502.

In step S1502, the CPU 305 determines whether the leading sheet on the feed waiting sheet queue is a sheet for duplex printing.

If, in step S1502, it is determined that the leading sheet on the feed waiting sheet queue is not a sheet for duplex printing (is a sheet for simplex printing) (NO in step S1502), the CPU 305 advances the processing to step S1503, and, if it is determined that the leading sheet on the feed waiting sheet queue is a sheet for duplex printing (YES in step S1502), the CPU 305 advances the processing to step S1507.

In step S1503, the CPU 305 determines whether a sheet for duplex printing is present “the number of sides for duplex circulation in ordinary duplex control—1” behind the leading sheet on the feed waiting sheet queue. The number of sides for duplex circulation in ordinary duplex control mentioned here is, for example, nine in the example illustrated in FIG. 12D.

If, in step S1503, it is determined that no sheet for duplex printing is present “the number of sides for duplex circulation in ordinary duplex control—1” behind (NO in step S1503), the CPU 305 advances the processing to step S1504, and then in step S1504, the CPU 305 performs feeding of the leading sheet for simplex printing on the feed waiting sheet queue.

On the other hand, if, in step S1503, it is determined that a sheet for duplex printing is present “the number of sides for duplex circulation in ordinary duplex control—1”behind (YES in step S1503), the CPU 305 advances the processing to step S1505.

In step S1505, the CPU 305 determines whether there is a vacancy in duplex waiting positions for overtaking duplex control. In the example illustrated in FIG. 12D, in a case where overtaking duplex control is applied, the number of sheets able to be fed in advance is up to three.

If, in step S1505, it is determined that there is a vacancy in duplex waiting positions for overtaking duplex control (YES in step S1505), the CPU 305 advances the processing to step S1506. In step S1506, the CPU 305 performs feeding of the sheet for duplex printing which is present “the number of sides for duplex circulation in ordinary duplex control—1” behind the leading sheet on the feed waiting sheet queue, found in step S1503.

On the other hand, if, in step S1505, it is determined that there is no vacancy in duplex waiting positions for overtaking duplex control (NO in step S1505), the CPU 305 advances the processing to step S1504, and then in step S1504, the CPU 305 performs feeding of the leading sheet for simplex printing on the feed waiting sheet queue.

In step S1507, the CPU 305 determines whether there is a vacancy in duplex waiting positions.

If, in step S1507, it is determined that there is a vacancy in duplex waiting positions (YES in step S1507), the CPU 305 advances the processing to step S1509, and, if it is determined that there is no vacancy in duplex waiting positions (NO in step S1507), the CPU 305 advances the processing to step S1508.

In step S1508, the CPU 305 determines whether sheets present at the duplex waiting positions have been refed.

Unless, in step S1508, refeeding of sheets present at the duplex waiting positions is performed (NO in step S1508), the CPU 305 advances the processing to step S1508 again, thus waiting for refeeding of the sheets, and, if refeeding of the sheets has been performed (YES in step S1508), the CPU 305 advances the processing to step S1509.

In step S1509, the CPU 305 performs feeding of the leading sheet for duplex printing on the feed waiting sheet queue.

In the case of the feed waiting sheet queues 1421 and 1422 in the example illustrated in FIG. 14, respective processing operations are sequentially performed in the order of steps S1501, S1502, S1503, and S1504 illustrated in FIG. 15. Thus, in this case, the leading sheet for simplex printing on the feed waiting sheet queue comes to be fed.

In the case of the feed waiting sheet queues 1423, 1424, and 1425 in the example illustrated in FIG. 14, respective processing operations are sequentially performed in the order of steps S1501, S1502, S1503, S1505, and S1506 illustrated in FIG. 15. Thus, in this case, not the leading sheet on the feed waiting sheet queue but the sheet for duplex printing found in step S1503 comes to be fed.

In the case of the feed waiting sheet queues 1426 to 1433 in the example illustrated in FIG. 14, respective processing operations are sequentially performed in the order of steps S1501, S1502, S1503, S1505, and S1504 illustrated in FIG. 15. Thus, in this case, the leading sheet for simplex printing on the feed waiting sheet queue comes to be fed.

In the case of the feed waiting sheet queues 1434 and 1435 in the example illustrated in FIG. 14, respective processing operations are sequentially performed in the order of steps S1501, S1502, S1507, and S1509 or steps S1501, S1502, S1507, S1508, and S1509 illustrated in FIG. 15. Thus, in this case, the leading sheet for duplex printing on the feed waiting sheet queue comes to be fed.

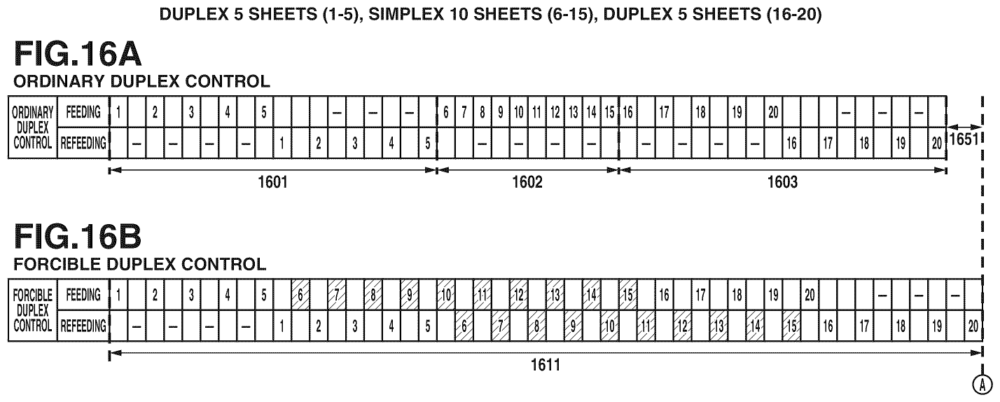

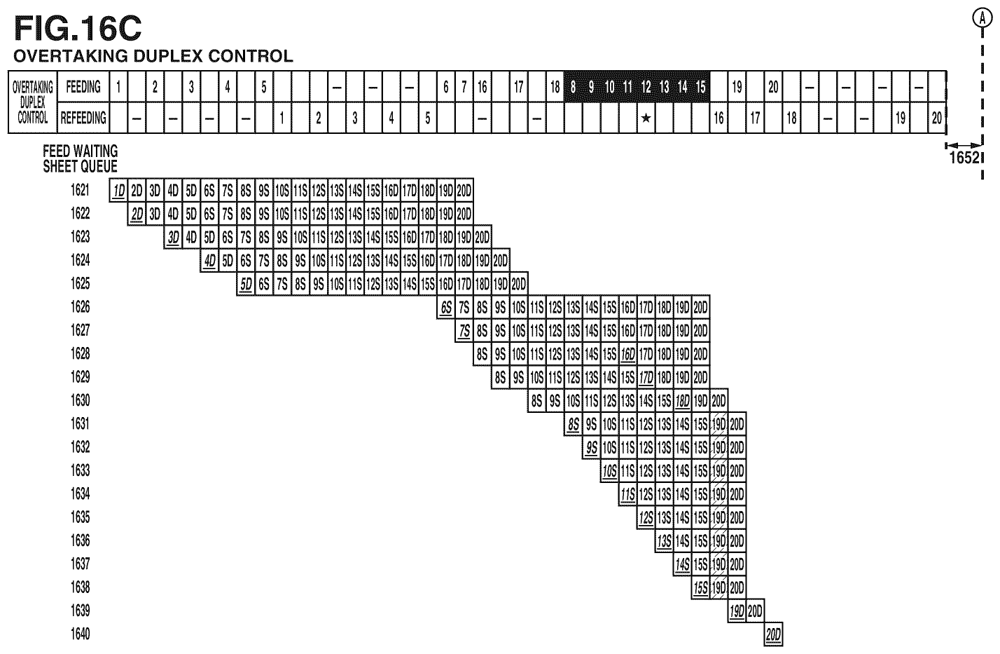

Yet another example of conveyance control which is performed in the image forming apparatus 101 according to the second embodiment is described with reference to FIGS. 16A, 16B, and 16C. FIGS. 16A to 16C illustrate examples of cases where ordinary duplex control, forcible duplex control, and overtaking duplex control have been applied, respectively, with respect to duplex 5 sheets (1-5), simplex 10 sheets (6-15), and duplex 5 sheets (16-20). Furthermore, FIG. 16A is similar to FIG. 10A described above and FIG. 16B is similar to FIG. 10B described above, and, therefore, the detailed description of FIGS. 16A and 16B is omitted here.

FIG. 16C illustrates an example of a case where overtaking duplex control has been applied. In the case of feed waiting sheet queues 1621 to 1625, respective processing operations are sequentially performed in the order of steps S1501, S1502, S1507, and S1509 illustrated in FIG. 15. Thus, in this case, the leading sheet for duplex printing on the feed waiting sheet queue comes to be fed.

In the case of feed waiting sheet queues 1626 and 1627, respective processing operations are sequentially performed in the order of steps S1501, S1502, S1503, and S1504 illustrated in FIG. 15. Thus, in this case, the leading sheet for simplex printing on the feed waiting sheet queue comes to be fed.

In the case of feed waiting sheet queues 1628 to 1630, respective processing operations are sequentially performed in the order of steps S1501, S1502, S1503, S1505, and S1506 illustrated in FIG. 15. Thus, in this case, not the leading sheet on the feed waiting sheet queue but the sheet for duplex printing found in step S1503 comes to be fed.

In the case of feed waiting sheet queues 1631 to 1638, respective processing operations are sequentially performed in the order of steps S1501, S1502, S1503, S1505, and S1504 illustrated in FIG. 15. Thus, in this case, the leading sheet for simplex printing on the feed waiting sheet queue comes to be fed.

In the case of feed waiting sheet queues 1639 and 1640, respective processing operations are sequentially performed in the order of steps S1501, S1502, S1507, and S1509 or steps S1501, S1502, S1507, S1508, and S1509 illustrated in FIG. 15. Thus, in this case, the leading sheet for duplex printing on the feed waiting sheet queue comes to be fed. Comparing performances of ordinary duplex control, forcible duplex control, and overtaking duplex control, it can be understood that ordinary duplex control and overtaking duplex control are better in performance by two sides than forcible duplex control, as denoted by a two-headed arrow 1651 and two-headed arrow 1652.

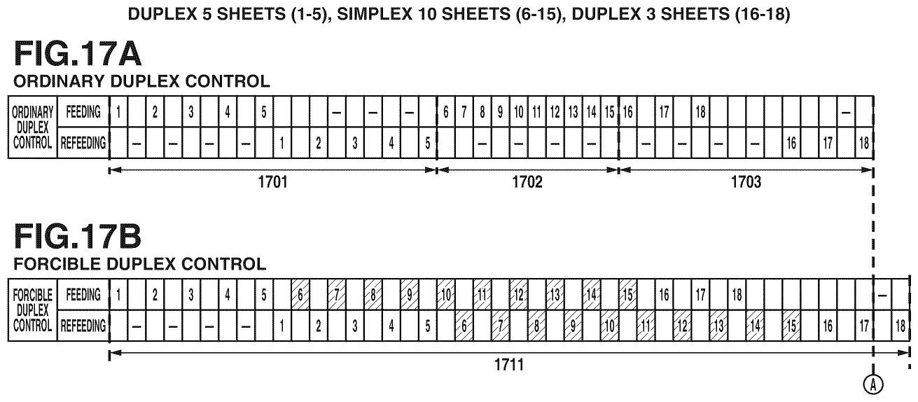

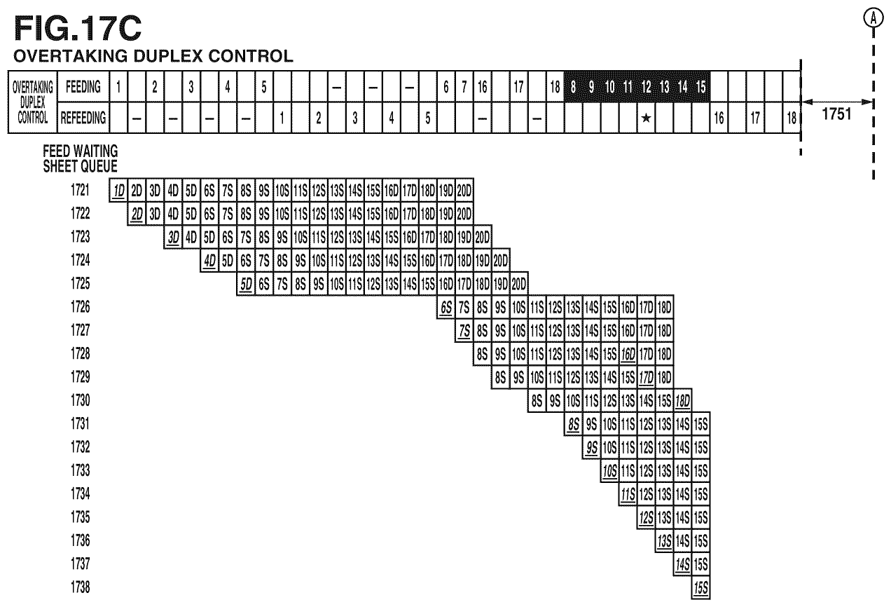

Yet another example of conveyance control which is performed in the image forming apparatus 101 according to the second embodiment is described with reference to FIGS. 17A, 17B, and 17C. FIGS. 17A to 17C illustrate examples of cases where ordinary duplex control, forcible duplex control, and overtaking duplex control have been applied, respectively, with respect to duplex 5 sheets (1-5), simplex 10 sheets (6-15), and duplex 3 sheets (16-18).

FIG. 17A illustrates an example of a case where ordinary duplex control has been applied. In the example illustrated in FIG. 17A, in a printing range 1701, duplex 5 sheets (1-5) are subjected to duplex printing with 9-side circulation, in a printing range 1702, simplex 10 sheets (6-15) are fed, and, in a printing range 1703, duplex 3 sheets (16-18) are fed with 9-side circulation.

FIG. 17B illustrates an example of a case where forcible duplex control has been applied. In the example illustrated in FIG. 17B, simplex 10 sheets (6-15) are caused to pass through a duplex conveyance path to be subjected to printing, and, in a printing range 1711, duplex printing control using 9-side circulation with duplex 5 sheets (1-5), simplex 10 sheets (6-15), and duplex 3 sheets (16-18) made continuous is performed.

FIG. 17C illustrates an example of a case where overtaking duplex control has been applied.

In the case of feed waiting sheet queues 1721 to 1725, respective processing operations are sequentially performed in the order of steps S1501, S1502, S1507, and S1509 illustrated in FIG. 15. Thus, in this case, the leading sheet for duplex printing on the feed waiting sheet queue comes to be fed.

In the case of feed waiting sheet queues 1726 and 1727, respective processing operations are sequentially performed in the order of steps S1501, S1502, S1503, and S1504 illustrated in FIG. 15. Thus, in this case, the leading sheet for simplex printing on the feed waiting sheet queue comes to be fed.

In the case of feed waiting sheet queues 1728 to 1730, respective processing operations are sequentially performed in the order of steps S1501, S1502, S1503, S1505, and S1506 illustrated in FIG. 15. Thus, in this case, not the leading sheet on the feed waiting sheet queue but the sheet for duplex printing found in step S1503 comes to be fed.

In the case of feed waiting sheet queues 1731 to 1738, respective processing operations are sequentially performed in the order of steps S1501, S1502, S1503, S1505, and S1504 illustrated in FIG. 15. Thus, in this case, the leading sheet for simplex printing on the feed waiting sheet queue comes to be fed.

While, in the example illustrated in FIGS. 16A to 16C, the performances of ordinary duplex control and overtaking duplex control are the same, in the example illustrated in FIGS. 17A to 17C, overtaking duplex control is better in performance by four sides than ordinary duplex control, as denoted by a two-headed arrow 1751.

The difference between the example illustrated in FIGS. 16A to 16C and the example illustrated in FIGS. 17A to 17C is the number of sheets for duplex printing following simplex 10 sheets (6-15). In the example illustrated in FIGS. 16A to 16C, the number of sheets for duplex printing is five (16-20), and, in the example illustrated in FIGS. 17A to 17C, the number of sheets for duplex printing is three (16-18). In overtaking duplex control, since the number of sides for duplex circulation is five, the number of sheets able to be fed in advance becomes three. If the number of sheets able to be fed in advance is three or less for duplex printing, overtaking duplex control becomes advantageous compared with ordinary duplex control. This is because, in a case where the number of sheets able to be fed in advance is greater than three for duplex printing, after a sheet for duplex printing which has been overtaken, it is necessary to perform duplex printing again with respect to only sheets for duplex printing. This is applicable to sheets 19 and 20 in the example illustrated in FIGS. 16A to 16C.

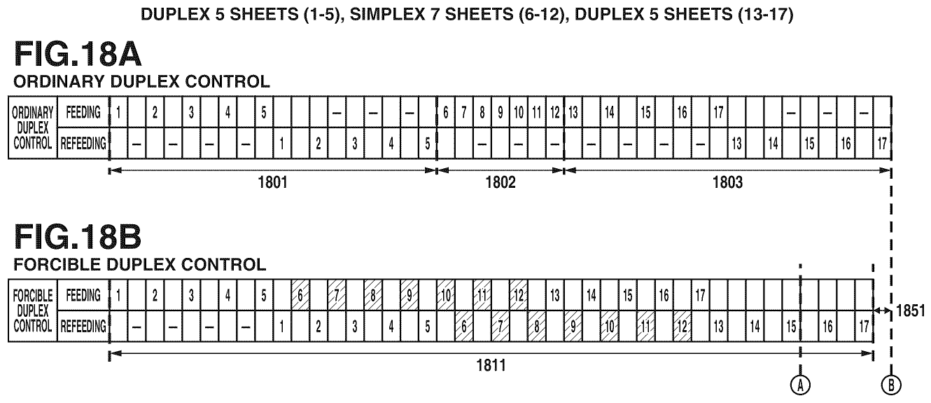

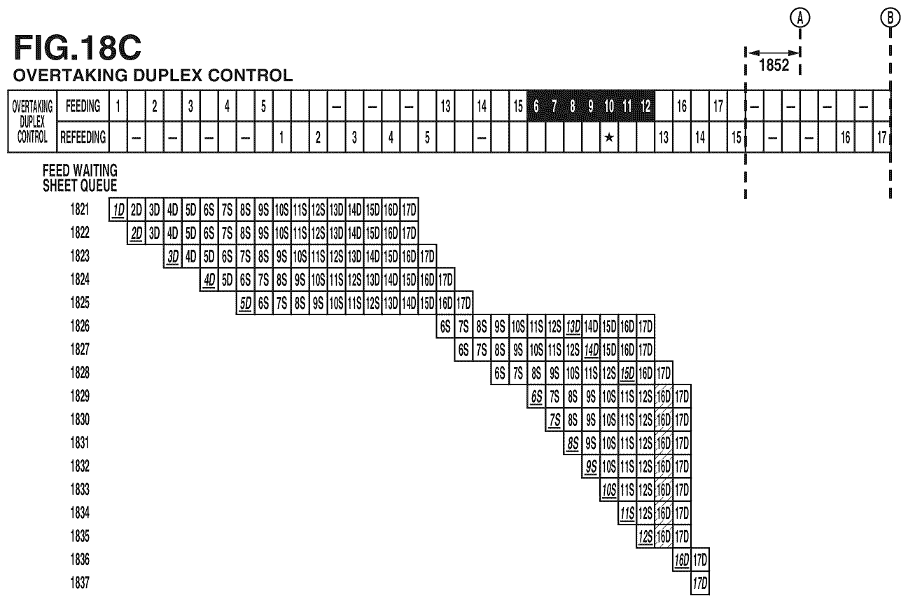

Yet another example of conveyance control which is performed in the image forming apparatus 101 according to the second embodiment is described with reference to FIGS. 18A, 18B, and 18C. FIGS. 18A to 18C illustrate examples of cases where ordinary duplex control, forcible duplex control, and overtaking duplex control have been applied, respectively, with respect to duplex 5 sheets (1-5), simplex 7 sheets (6-12), and duplex 5 sheets (13-17).

FIG. 18A illustrates an example of a case where ordinary duplex control has been applied. In the example illustrated in FIG. 18A, in a printing range 1801, duplex 5 sheets (1-5) are subjected to duplex printing with 9-side circulation, in a printing range 1802, simplex 7 sheets (6-12) are fed, and, in a printing range 1803, duplex 5 sheets (13-17) are fed with 9-side circulation.

FIG. 18B illustrates an example of a case where forcible duplex control has been applied. In the example illustrated in FIG. 18B, simplex 7 sheets (6-12) are caused to pass through a duplex conveyance path to be subjected to printing, and, in a printing range 1811, duplex printing control using 9-side circulation with duplex 5 sheets (1-5), simplex 7 sheets (6-12), and duplex 5 sheets (13-17) made continuous is performed.

FIG. 18C illustrates an example of a case where overtaking duplex control has been applied.

In the case of feed waiting sheet queues 1821 to 1825, respective processing operations are sequentially performed in the order of steps S1501, S1502, S1507, and S1509 illustrated in FIG. 15. Thus, in this case, the leading sheet for duplex printing on the feed waiting sheet queue comes to be fed.

In the case of feed waiting sheet queues 1826 to 1828, respective processing operations are sequentially performed in the order of steps S1501, S1502, S1503, S1505, and S1506 illustrated in FIG. 15. Thus, in this case, not the leading sheet on the feed waiting sheet queue but the sheet for duplex printing found in step S1503 comes to be fed.

In the case of feed waiting sheet queues 1829 and 1835, respective processing operations are sequentially performed in the order of steps S1501, S1502, S1503, S1505, and S1504 illustrated in FIG. 15. Thus, in this case, the leading sheet for simplex printing on the feed waiting sheet queue comes to be fed.

In the case of feed waiting sheet queues 1836 and 1837, respective processing operations are sequentially performed in the order of steps S1501, S1502, S1507, and S1509 or steps S1501, S1502, S1507, S1508, and S1509 illustrated in FIG. 15. Thus, in this case, the leading sheet for duplex printing on the feed waiting sheet queue comes to be fed.

In each of the examples illustrated in FIGS. 16A to 16C and FIGS. 17A to 17C, as mentioned above, the application of forcible duplex control in a case where the number of sheets for simplex printing present between sheet bundles for duplex printing is relatively large becomes disadvantageous in performance.

The example illustrated in FIGS. 18A to 18C shows that, when “the number of sides for duplex circulation in ordinary duplex control—1” is set as a threshold value for the number of sheets in a sheet bundle for simplex printing present between two sheet bundles for duplex printing, the case where forcible duplex control or overtaking duplex control is applied becomes more advantageous than the case where ordinary duplex control is applied. Specifically, the case where forcible duplex control is applied is better in performance by one side than the case where ordinary duplex control is applied, as denoted by a two-headed arrow 1851. Additionally, in consideration of the case where, as in the example illustrated in FIGS. 17A to 17C, the number of sheets in a sheet bundle for duplex printing following a sheet for simplex printing is three, the case where overtaking duplex control is applied becomes advantageous as compared with the case where forcible duplex control is applied. In a case where the number of sheets for duplex printing following simplex 7 sheets (6-12) is three (13-15), the case where overtaking duplex control is applied is better in performance by three sides than the case where forcible duplex control is applied, as denoted by a two-headed arrow 1852.

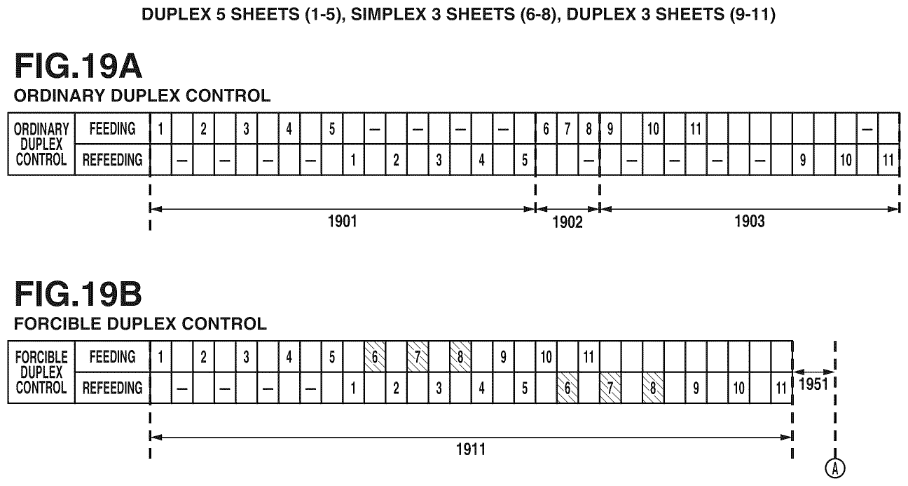

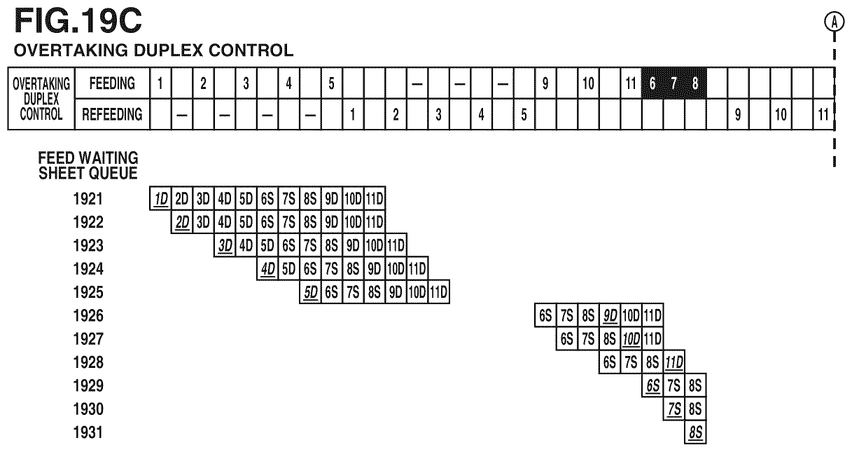

Yet another example of conveyance control which is performed in the image forming apparatus 101 according to the second embodiment is described with reference to FIGS. 19A, 19B, and 19C. FIGS. 19A to 19C illustrate examples of cases where ordinary duplex control, forcible duplex control, and overtaking duplex control have been applied, respectively, with respect to duplex 5 sheets (1-5), simplex 3 sheets (6-8), and duplex 3 sheets (9-11).

FIG. 19A illustrates an example of a case where ordinary duplex control has been applied. In the example illustrated in FIG. 19A, in a printing range 1901, duplex 5 sheets (1-5) are subjected to duplex printing with 9-side circulation, in a printing range 1902, simplex 3 sheets (6-8) are fed, and, in a printing range 1903, duplex 3 sheets (9-11) are fed with 9-side circulation.

FIG. 19B illustrates an example of a case where forcible duplex control has been applied. In the example illustrated in FIG. 19B, simplex 3 sheets (6-8) are caused to pass through a duplex conveyance path to be subjected to printing, and, in a printing range 1911, duplex printing control using 9-side circulation with duplex 5 sheets (1-5), simplex 3 sheets (6-8), and duplex 3 sheets (9-11) made continuous is performed.

FIG. 19C illustrates an example of a case where overtaking duplex control has been applied.

In the case of feed waiting sheet queues 1921 to 1925, respective processing operations are sequentially performed in the order of steps S1501, S1502, S1507, and S1509 illustrated in FIG. 15. Thus, in this case, the leading sheet for duplex printing on the feed waiting sheet queue comes to be fed.

In the case of feed waiting sheet queues 1926 to 1928, respective processing operations are sequentially performed in the order of steps S1501, S1502, S1503, S1505, and S1506 illustrated in FIG. 15. Thus, in this case, not the leading sheet on the feed waiting sheet queue but the sheet for duplex printing found in step S1503 comes to be fed.

In the case of feed waiting sheet queues 1929 and 1931, respective processing operations are sequentially performed in the order of steps S1501, S1502, S1503, S1505, and S1504 illustrated in FIG. 15. Thus, in this case, the leading sheet for simplex printing on the feed waiting sheet queue comes to be fed.

The above example illustrated in FIGS. 18A to 18C has shown that, when “the number of sides for duplex circulation in ordinary duplex control—1” is set as a threshold value for the number of sheets in a sheet bundle for simplex printing present between two sheet bundles for duplex printing, the case where forcible duplex control or overtaking duplex control is applied becomes more advantageous than the case where ordinary duplex control is applied. Additionally, the example illustrated in FIGS. 19A to 19C shows that, in a case where the number of sheets in a sheet bundle for simplex printing present between two sheet bundles for duplex printing is smaller, the case where forcible duplex control is applied becomes advantageous as compared with the case where overtaking duplex control is applied. The threshold value in this case is “(the number of sides for duplex circulation in ordinary duplex control +1)/2”. In this case, it can be understood that the case where forcible duplex control is applied is better in performance by two sides than the case where overtaking duplex control is applied, as denoted by a two-headed arrow 1951.

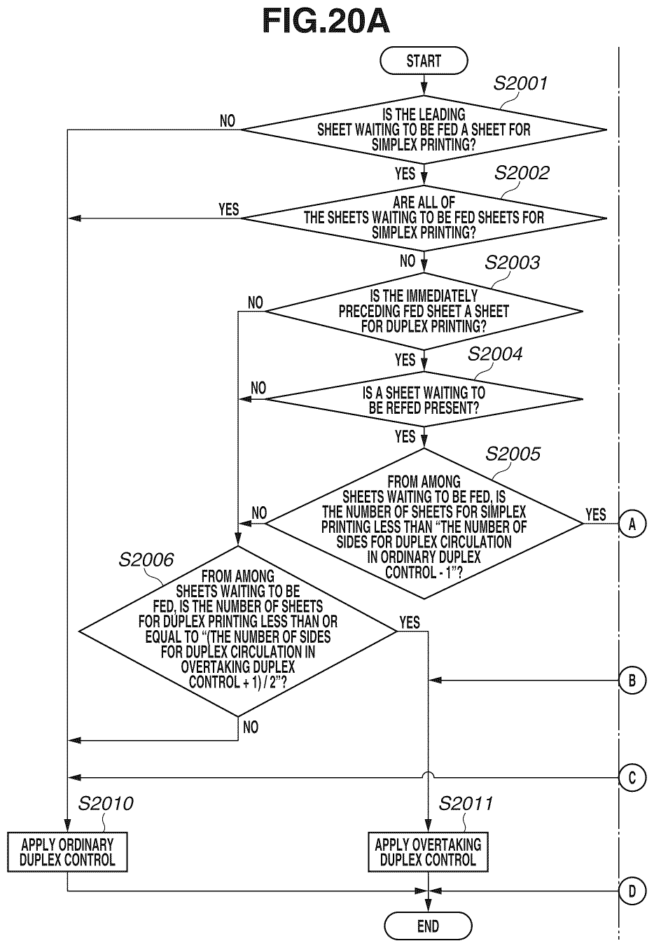

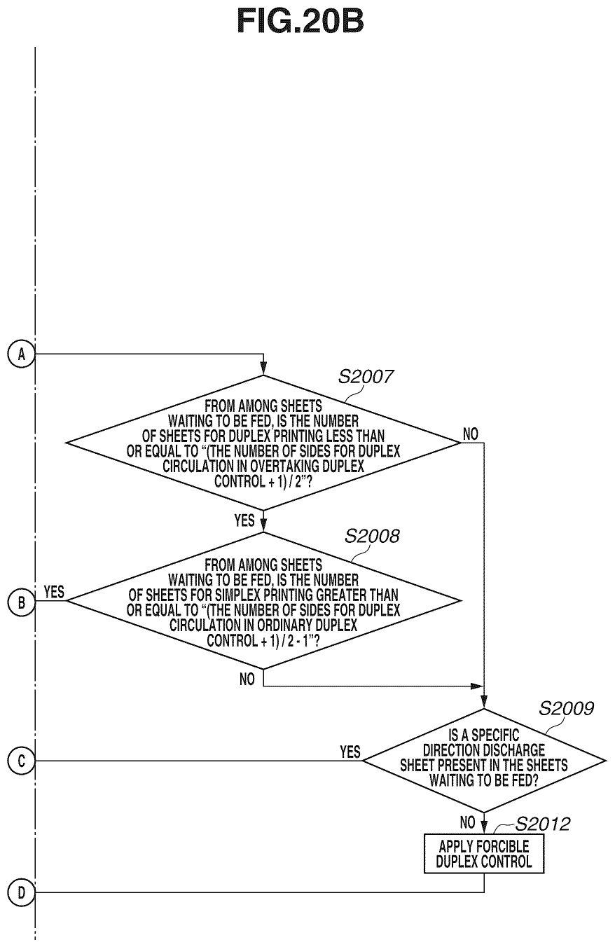

An example of processing which is performed in the image forming apparatus 101 according to the second embodiment is described with reference to FIGS. 20A and 20B, particularly, with a focus put on processing concerning switching between ordinary duplex control, overtaking duplex control, and forcible duplex control.

In step S2001, the CPU 305 determines whether the leading sheet on a feed waiting sheet queue retained in the RAM 306 is a sheet for simplex printing.

If, in step S2001, it is determined that the leading sheet is a sheet for simplex printing (YES in step S2001), the CPU 305 advances the processing to step S2002, and, if is determined that the leading sheet is a sheet for duplex printing (NO in step S2001), the CPU 305 advances the processing to step S2010. Furthermore, in a case where the leading sheet on the sheet queue is a sheet for duplex printing, since both sides thereof are already targeted for conveyance, it becomes difficult to perform control for causing a sheet for simplex printing to pass through a duplex conveyance path, such as forcible duplex control. Therefore, in that case, in step S2010, the CPU 305 applies ordinary duplex control.

In step S2002, the CPU 305 determines whether all of the sheets waiting to be fed are sheets for simplex printing.

If, in step S2002, it is determined that all of the sheets are sheets for simplex printing (YES in step S2002), the CPU 305 advances the processing to step S2010, and, if it is determined that not all of the sheets are sheets for simplex printing (at least one sheet is a sheet for duplex printing) (NO in step S2002), the CPU 305 advances the processing to step S2003. Furthermore, in a case where all of the sheets are sheets for simplex printing, since the job is not in the state of including a mixture of simplex printing and duplex printing, the CPU 305 determines that control for improving performance during a mixture of simplex printing and duplex printing, such as forcible duplex control, itself becomes meaningless. Therefore, in that case, in step S2010, the CPU 305 applies ordinary duplex control and thus performs simplex printing for sheets for simplex printing.

In step S2003, the CPU 305 determines whether the immediately preceding fed sheet is a sheet for duplex printing.

If, in step S2003, it is determined that the immediately preceding fed sheet is a sheet for duplex printing (YES in step S2003), the CPU 305 advances the processing to step S2004, and, if it is determined that the immediately preceding fed sheet is not a sheet for duplex printing (is a sheet for simplex printing) (NO in step S2003), the CPU 305 advances the processing to step S2006. Step S2006 is processing which is performed in a case where forcible duplex control has been excluded from the applicable targets. Forcible duplex control, which continues duplex circulation following an already fed sheet bundle for duplex printing, is not possible in a case where the immediately preceding fed sheet is a sheet for simplex printing. Therefore, in a case where the immediately preceding fed sheet is a sheet for simplex printing, forcible duplex control is excluded from the applicable targets. Furthermore, the effect that, in a case where the immediately preceding fed sheet is a sheet for simplex printing, applying forcible duplex control brings disadvantages is as described above with reference to FIGS. 9A and 9B.

In step S2004, the CPU 305 determines whether a sheet waiting to be refed is present.

If, in step S2004, it is determined that a sheet waiting to be refed is present (YES in step S2004), the CPU 305 advances the processing to step S2005, and, if it is determined that no sheet waiting to be refed is present (NO in step S2004), the CPU 305 advances the processing to step S2006. Furthermore, in a case where the immediately preceding fed sheet is not a sheet waiting to be refed for duplex printing, the immediately preceding fed sheet is in the state of having already been discharged as a sheet for duplex printing to outside the apparatus. Forcible duplex control is control which continues duplex circulation following an already fed sheet bundle for duplex printing and is, therefore, not possible in the state in which no sheet waiting to be refed is present and duplex circulation is cut out. Therefore, in a case where no sheet waiting to be refed is present, the CPU 305 excludes forcible duplex control from the applicable targets.

In step S2005, the CPU 305 determines whether, from among sheets waiting to be fed, the number of sheets for simplex printing is less than “the number of sides for duplex circulation in ordinary duplex control—1”.

If, in step S2005, it is determined that the number of sheets for simplex printing is less than “the number of sides for duplex circulation in ordinary duplex control—1” (YES in step S2005), the CPU 305 advances the processing to step S2007, and, if it is determined that the number of sheets for simplex printing is greater than or equal to “the number of sides for duplex circulation in ordinary duplex control—1” (NO in step S2005), the CPU 305 advances the processing to step S2006. Furthermore, in a case where a sheet bundle for duplex printing, a sheet bundle for simplex printing, and a sheet bundle for duplex printing have been made continuous in this order, if the number of sheets in the sheet bundle for simplex printing is large (is greater than or equal to “the number of sides for duplex circulation in ordinary duplex control—1”), the case where forcible duplex control has been applied brings more disadvantages in performance than the case where ordinary duplex control has been applied. Therefore, the CPU 305 restricts applying forcible duplex control. Furthermore, the decrease in performance caused by the application of forcible duplex control in this case is as described above with reference to FIGS. 16A to 16C.

In step S2006, the CPU 305 determines whether, from among sheets waiting to be fed, the number of sheets for duplex printing is less than or equal to “(the number of sides for duplex circulation in overtaking duplex control +1)/2”.

If, in step S2006, it is determined that the number of sheets for duplex printing is less than or equal to “(the number of sides for duplex circulation in overtaking duplex control +1)/2” (YES in step S2006), the CPU 305 advances the processing to step S2011, and then in step S2011, the CPU 305 applies overtaking duplex control.

On the other hand, if, in step S2006, it is determined that the number of sheets for duplex printing is greater than “(the number of sides for duplex circulation in overtaking duplex control +1)/2” (NO in step S2006), the CPU 305 advances the processing to step S2010, and then in step S2010, the CPU 305 applies ordinary duplex control. This is because, in a case where the number of sheets for duplex printing is greater than “(the number of sides for duplex circulation in overtaking duplex control +1)/2”, duplex circulation is unable to be continued, so that a sheet for duplex printing which becomes wasteful is present. This case is as described above with reference to FIGS. 17A to 17C. In the example illustrated in FIGS. 16A to 16C, duplex 5 sheets (1-5), simplex 10 sheets (6-15), and duplex 5 sheets (16-20) are used. On the other hand, in the example illustrated in FIGS. 17A to 17C, duplex 5 sheets (1-5), simplex 10 sheets (6-15), and duplex 3 sheets (16-18) are used, so that the number of sheets for duplex printing in the sheet bundle for duplex printing following the sheet bundle for simplex printing is smaller than that in the example illustrated in FIGS. 16A to 16C. Therefore, a sheet which is unable to be subjected to duplex circulation and is subjected to duplex printing only later, such as the sheet 19 or 20 in the example illustrated in FIG. 16C, is not present in the example illustrated in FIG. 17C, so that the case where overtaking duplex control is applied becomes better in performance than the case where ordinary duplex control is applied.

In step S2007, the CPU 305 determines whether, from among sheets waiting to be fed, the number of sheets for duplex printing is less than or equal to “(the number of sides for duplex circulation in overtaking duplex control +1)/2”.

If, in step S2007, it is determined that the number of sheets for duplex printing is less than or equal to “(the number of sides for duplex circulation in overtaking duplex control +1)/2” (YES in step S2007), the CPU 305 advances the processing to step S2008, and, if it is determined that the number of sheets for duplex printing is greater than “(the number of sides for duplex circulation in overtaking duplex control +1)/2” (NO in step S2007), the CPU 305 advances the processing to step S2009.

The case in which a processing operation in step S2007 is performed is equivalent to the case where, by the respective condition determinations performed in steps S2003, S2004, and S2005, it has been determined that the number of sheets for simplex printing present between a sheet bundle for duplex printing is small to some extent. Thus, it can be determined that the case where overtaking duplex control or forcible duplex control is applied is more advantageous than the case where ordinary duplex control is applied. This case is as described above with reference to FIGS. 18A to 18C.

Moreover, in the processing operation in step S2007, as with the processing operation in step S2006, a check is made to determine whether, at the time of overtaking duplex control, a sheet for duplex printing which is unable to be subjected to duplex circulation and becomes wasteful is present. In the case where the sixteenth and seventeenth sheets for duplex printing, which are unable to be subjected to duplex circulation and become wasteful, are present as in the example illustrated in FIG. 18C, the case where forcible duplex control is applied is better in performance than the case where overtaking duplex control is applied, as in the example illustrated in FIG. 18B. On the other hand, in the case of up to the fifteenth sheet, in which the sixteenth and seventeenth sheets for duplex printing are not present, the case where overtaking duplex control is applied is better in performance than the case where forcible duplex control is applied, as in the example illustrated in FIG. 18C.

In step S2008, the CPU 305 determines whether, from among sheets waiting to be fed, the number of sheets for simplex printing is greater than or equal to “(the number of sides for duplex circulation in ordinary duplex control +1)/2−1”.

If, in step S2008, it is determined that the number of sheets for simplex printing is greater than or equal to “(the number of sides for duplex circulation in ordinary duplex control +1)/2−1” (YES in step S2008), the CPU 305 advances the processing to step S2011, and then in step S2011, the CPU 305 applies overtaking duplex control.

On the other hand, if, in step S2008, it is determined that the number of sheets for simplex printing is less than “(the number of sides for duplex circulation in ordinary duplex control +1)/2−1” (NO in step S2008), the CPU 305 advances the processing to step S2009. This case is as described above with reference to FIGS. 19A to 19C. Specifically, this case shows that, even in a case where the application of overtaking duplex control in which a sheet for duplex printing which is unable to be subjected to duplex circulation and becomes wasteful is not present is advantageous, if the number of sheets for simplex printing present between a sheet bundle for duplex printing is more smaller, the case where forcible duplex control is applied is more advantageous.

In step S2009, the CPU 305 determines whether a specific direction discharge sheet is present in the sheets waiting to be fed.

If, in step S2009, it is determined that a specific direction discharge sheet is present in the sheets waiting to be fed (YES in step S2009), the CPU 305 advances the processing to step S2010, and then in step S2010, the CPU 305 applies ordinary duplex control.

On the other hand, if, in step S2009, it is determined that no specific direction discharge sheet is present in the sheets waiting to be fed (NO in step S2009), the CPU 305 advances the processing to step S2012, and then in step S2012, the CPU 305 applies forcible duplex control.

This is because, with regard to the application of the above-described control operations, as mentioned above with reference to FIGS. 5A to 5C, if the control to be applied to a specific direction discharge sheet is changed from simplex printing to duplex printing, the direction of the specific direction discharge sheet is changed, so that it may become impossible to obtain a printed product which the user has expected.

As described above, with respect to a specific direction discharge sheet, the image forming apparatus 101 according to the second embodiment does not apply forcible duplex control but allows overtaking duplex control to be applied. The application of such control operations enables, while providing performance in a more favorable manner than in the first embodiment, outputting a printed product which the user expects in a case where a specific direction discharge sheet is used.

Furthermore, while a preprinted sheet has been cited as an example of a specific direction discharge sheet, besides a preprinted sheet, there is a sheet the direction of which is important as a printed product. For example, a one-sided coated sheet, a pre-punched sheet, an envelope, or a postcard is applicable to the sheet the direction of which is important as a printed product. Therefore, in the present disclosure, it is assumed that a sheet the direction of which is important as a printed product, such as, not only a preprinted sheet, a one-sided coated sheet, a pre-punched sheet, an envelope, or a postcard is applicable to the specific direction discharge sheet.

The present disclosure can also be implemented by processing for supplying a program for implementing one or more functions of the above-described embodiments to a system or apparatus via a network or a storage medium and causing one or more processors included in a computer of the system or apparatus to read out and execute the program. Moreover, the present disclosure can also be implemented by a circuit which implements one or more functions of the above-described embodiments (for example, an application specific integrated circuit (ASIC)).

According to an aspect of the present disclosure, it becomes possible to perform outputting of a printed product which the user expects, while providing more appropriate performance, even under a situation in which there is a mixture of simplex printing and duplex printing.

### Other embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-160838 filed Sep. 18, 2024, which is hereby incorporated by reference herein in its entirety.

What is claimed is:

1. A printing apparatus capable of executing a print job including a mixture of simplex printing and duplex printing, the printing apparatus comprising:
a feeding unit configured to feed a sheet held in a predetermined sheet holding unit;
a refeeding unit configured to, in a sheet conveyance path having a plurality of waiting positions for, to print an image on a second surface of a target sheet having a first surface thereof subjected to printing in duplex printing, causing the target sheet to wait, refeed the target sheet from a predetermined waiting position of the plurality of waiting positions; and
a control unit configured to control execution of a print job,
wherein the control unit performs a plurality of print control operations including at least a first print control operation which performs simplex printing on a sheet subjected to an instruction for simplex printing and performs duplex printing on a sheet subjected to an instruction for duplex printing and a second print control operation which applies, to a sheet subjected to an instruction for simplex printing present between a plurality of sheets subjected to an instruction for duplex printing, conveyance control equivalent to that for a sheet subjected to an instruction for duplex printing in such a way as to cause the sheet subjected to an instruction for simplex printing to be conveyed through a conveyance path for duplex printing of the sheet conveyance path after simplex printing, while selectively switching between the plurality of print control operations based on a printing order of simplex printing and duplex printing in a target print job, a number of the plurality of waiting positions, and a number of sheets for at least any one of simplex printing and duplex printing of sheets waiting to be fed, and,
wherein, in a case where, in sheets targeted for feeding, a predetermined sheet designated in such a manner that, when being discharged, a predetermined surface thereof faces in a predetermined direction is included, the control unit restricts application of the second print control operation.

2. The printing apparatus according to claim 1,
wherein the plurality of print control operations further includes a third print control operation in which, in advance of a sheet subjected to an instruction for simplex printing, printing on a first side of a subsequent sheet subjected to an instruction for duplex printing is performed in first and, before printing on a second side of the sheet subjected to an instruction for duplex printing, simplex printing for the sheet subjected to an instruction for simplex printing is performed, and
wherein, even in a case where the predetermined sheet is included in the sheets targeted for feeding, the control unit allows application of the third print control operation.

3. The printing apparatus according to claim 1, wherein the predetermined sheet includes at least any one of a preprinted sheet, a one-sided coated sheet, a pre-punched sheet, an envelope, and a postcard.

4. A control method for a printing apparatus capable of executing a print job including a mixture of simplex printing and duplex printing, the control method comprising:
feeding a sheet held in a predetermined sheet holding unit;
in a sheet conveyance path having a plurality of waiting positions for, to print an image on a second surface of a target sheet having a first surface thereof subjected to printing in duplex printing, causing the target sheet to wait, refeeding the target sheet from a predetermined waiting position of the plurality of waiting positions; and
controlling execution of a print job,
wherein the controlling performs a plurality of print control operations including at least a first print control operation which performs simplex printing on a sheet subjected to an instruction for simplex printing and performs duplex printing on a sheet subjected to an instruction for duplex printing and a second print control operation which applies, to a sheet subjected to an instruction for simplex printing present between a plurality of sheets subjected to an instruction for duplex printing, conveyance control equivalent to that for a sheet subjected to an instruction for duplex printing in such a way as to cause the sheet subjected to an instruction for simplex printing to be conveyed through a conveyance path for duplex printing of the sheet conveyance path after simplex printing, while selectively switching between the plurality of print control operations based on a printing order of simplex printing and duplex printing in a target print job, a number of the plurality of waiting positions, and a number of sheets for at least any one of simplex printing and duplex printing of sheets waiting to be fed, and,
wherein, in a case where, in sheets targeted for feeding, a predetermined sheet designated in such a manner that, when being discharged, a predetermined surface thereof faces in a predetermined direction is included, the controlling restricts application of the second print control operation.

5. A non-transitory computer-readable storage medium storing computer-executable instructions that, when executed by a computer, cause the computer to perform a control method for a printing apparatus capable of executing a print job including a mixture of simplex printing and duplex printing, the control method comprising:
feeding a sheet held in a predetermined sheet holding unit;
in a sheet conveyance path having a plurality of waiting positions for, to print an image on a second surface of a target sheet having a first surface thereof subjected to printing in duplex printing, causing the target sheet to wait, refeeding the target sheet from a predetermined waiting position of the plurality of waiting positions; and
controlling execution of a print job,
wherein the controlling performs a plurality of print control operations including at least a first print control operation which performs simplex printing on a sheet subjected to an instruction for simplex printing and performs duplex printing on a sheet subjected to an instruction for duplex printing and a second print control operation which applies, to a sheet subjected to an instruction for simplex printing present between a plurality of sheets subjected to an instruction for duplex printing, conveyance control equivalent to that for a sheet subjected to an instruction for duplex printing in such a way as to cause the sheet subjected to an instruction for simplex printing to be conveyed through a conveyance path for duplex printing of the sheet conveyance path after simplex printing, while selectively switching between the plurality of print control operations based on a printing order of simplex printing and duplex printing in a target print job, a number of the plurality of waiting positions, and a number of sheets for at least any one of simplex printing and duplex printing of sheets waiting to be fed, and,
wherein, in a case where, in sheets targeted for feeding, a predetermined sheet designated in such a manner that, when being discharged, a predetermined surface thereof faces in a predetermined direction is included, the controlling restricts application of the second print control operation.
